(19) United States
(12) Patent Application Publication
(10) Pub. No.: US 2025/0088796 A1
(43) Pub. Date: Mar. 13, 2025

(54) Audio Signal Extraction from Audio Mixture using Neural Network

(71) Applicant: Mitsubishi Electric Research Laboratories, Inc., Cambridge, MA (US)

(72) Inventors: Gordon Wichern, Boston, MA (US); Ricardo Falcon-Perez, Espoo, FL (US); François G Germain, Quincy, MA (US); Jonathan Le Roux, Arlington, MA (US)

(73) Assignee: Mitsubishi Electric Research Laboratories, Inc., Cambridge, MA (US)

(21) Appl. No.: 18/463,388

(22) Filed: Sep. 8, 2023

(51) Int. Cl. H04R 3/00; G01M 99/00; G06F 3/16; G06N 3/0442; G06N 3/0455; G06N 3/0464; G06N 3/08; H04R 5/027; H04S 3/00; H04S 7/00

(52) U.S. Cl. CPC H04R 3/005; G01M 99/005; G06F 3/162; G06N 3/0442; G06N 3/0455; G06N 3/0464; G06N 3/08; H04R 5/027; H04S 3/008; H04S 7/00; H04R 2201/401; H04S 2400/01; H04S 2400/15

(57) ABSTRACT

The present disclosure provides an audio system, a method and a system for facilitating operation of a machine. The machine includes actuators assisting tools to perform tasks. In an example, the audio system is configured to receive an audio mixture of signals generated by audio sources including at least one of the tools performing the tasks, or the actuators. The audio sources forming the audio mixture are identified by a location relative to a location of each microphone of a microphone array measuring the audio mixture. The audio system is configured to extract an audio signal from the audio mixture generated by an identified audio source, based on a correlation of spectral features in a multi-channel spectrogram of the audio mixture with directional information indicative of the relative location of the identified audio source. The audio system outputs the extracted audio signal to facilitate the operation of the machine.

### TECHNICAL FIELD

This disclosure relates generally to sound separation using machine learning, and particularly to extracting isolated audio signals from acoustic mixtures using machine learning.

### BACKGROUND

Monitoring and controlling safety and quality are important in machines, where fast and powerful apparatuses or devices can execute complex sequences of operations at high speeds. Deviations from an intended sequence of operations or timing can degrade quality, waste raw materials, cause down times and broken equipment, and decrease output. Moreover, in some cases, any deviation may also pose a danger to workers. For this reason, it is important to design processes to minimize unexpected events, and safeguards also need to be designed, using a variety of sensors and emergency switches.

One practical approach to increasing the safety and minimizing the loss of material and output is to detect when a machine is operating abnormally, and stop the machine, if necessary, in such cases. One way to implement this approach is to use a description of normal operation of the machine in terms of ranges of measurable variables, for example, temperature, pressure, etc., defining an admissible operating region, and detecting operating points out of that region. This method is common in process manufacturing industries, for example, oil refining, where there is usually a good understanding of permissible ranges for physically measurable variables, and quality metrics for the product quality defined directly in terms of these variables.

However, in certain cases, deviations from normal working process may have quite different characteristics. For example, anomalies may include incorrect execution of one or more tasks, or an incorrect order of the tasks. Even in anomalous situations, often no physical variables, such as temperature or pressure are out of range, so direct monitoring of such variables cannot detect such anomalies reliably.

In certain cases, complex systems may include a combination of process and operations. When the processes and operations are intermingled on a signal production line machine, the anomaly detection methods designed for different types of manufacturing can be inaccurate. To that end, it is natural to design different anomaly detection methods for different classes of operations. One such anomaly detection method may be implemented based on audio processing of sound generated by machinery, during its operation.

In the realm of audio processing, the challenge of isolating distinct audio sources from a combined audio mixture has persisted as a complex and intricate problem. This issue arises in a multitude of scenarios, such as isolating vocals from instrumental music, separating multiple speakers in a recorded conversation, extracting specific sound events from a noisy background, extracting specific sound of a tool or an actuator in a machine, extracting sound of a particular vehicle from a convoy, etc.

In an example, when monitoring machine performance and health, highly skilled human operators may use their ears to listen to sounds produced during machine operation. As automation increases, algorithms that use microphones to monitor machine sounds are becoming increasingly important. In light of this, use of anomalous sound detection techniques where automated algorithms may determine whether sound produced during machine operation is normal or anomalous has increased.

Recently, research is increasingly performed to solve difficult problem setups where only normal data is available for training. In such a case, domain shift causes changes in sound signal unrelated to the presence or absence of anomalous sound. However, much of the existing literature on machine sound analysis treats the recorded sound as being produced by a single machine part. However, in practice, most industrial machinery is composed of multiple sound-producing components or parts, and we may want to monitor the health of each component individually.

In these situations, audio source separation could be a useful pre-processing step to isolate the sound from each machine part, and separated sound signals from each part may then be used as input for downstream processing, such as anomalous sound detection or other types of audio monitoring. Audio source separation techniques have been used in the areas of speech enhancement, speech separation, music source separation, and general sound separation. Traditional methods of audio source separation have predominantly relied on basic filtering techniques, such as bandpass filters or spectral subtraction. While these techniques provide some degree of separation, they often lack the ability to effectively distinguish between closely overlapping audio sources or manage complex sound environments with varying spectral and temporal characteristics.

In recent years, advancements in digital signal processing have led to the development of more sophisticated algorithms for audio source separation. Techniques such as Independent Component Analysis (ICA), Non-Negative Matrix Factorization (NMF), and deep learning-based methods may be used for audio signal extraction or separation. However, these approaches still face limitations in terms of separating sources with high similarity in spectral content and achieving close to real-time processing. Furthermore, existing solutions based on the deep learning techniques use a fully supervised framework, where a database of isolated sound signals is used to create artificial mixture signals that the source separation model is trained to separate using the ground-truth isolated signals as targets. Therefore, for separating machine parts, collecting a database of isolated signals from individual parts may not be possible, as all parts of the machine may need to operate simultaneously for the machine to run, and we must thus consider approaches with limited supervision.

The existing deep learning solutions tend to focus on specific types of audio sources or require isolated or separated sound signals of different audio sources for training, which may not be readily available in many practical situations. For example, for a machine comprising multiple tools and/or actuators that may operate together, separately or in a combination to perform one or more tasks, separate audio signals from the different tools and/or actuators may not be available or practically feasible to obtain.

Therefore, there is a need for an improved audio separation technique that addresses the limitations of current methods, provides enhanced separation performance even in complex and challenging acoustic environments, and offers flexibility in managing a wide range of audio source types without relying heavily on predefined models or assumptions.

### SUMMARY

It is an object of some embodiments to provide a system and a method suitable for acoustic separation of an audio mixture from complex industrial systems having multiple actuators actuating one or multiple tools to perform one or multiple tasks. Additionally or alternatively, it is an object of some embodiments to use machine learning to estimate the state of performance of these tasks, detect anomalies in operation of the industrial systems, and control the systems accordingly.

Some embodiments are based on a recognition that deep-learning-based techniques can be used for audio source separation, and for anomalous sound detection. For these systems, automated algorithms determine whether sound produced during machine operation is normal or anomalous.

Some embodiments are based on an understanding that it is natural to equate a state of a system to a state of performance of a task, because quite often it is possible to measure or observe only the state of the system, and if enough observations are collected, the state of the system can indeed represent the state of the performance. However, in some situations, the state of the system is difficult to measure, and the state of performance of the task is difficult to define.

For example, consider a computer numerical control (CNC) for machining a workpiece with a cutting tool. The state of the system includes states of actuators moving the cutting tool along a tool path. The state of performance of the machine is the state of the actual cutting. Industrial CNC systems can have a number of different and sometimes redundant actuators with a number of state variables in complex non-linear relationships with each posing difficulties on observing the state of the CNC systems. However, it also can be difficult to measure a state of machining of the workpiece.

Some embodiments are based on the realization that a state of performance of a task can be represented by an acoustic signal generated by such performance. For example, a state of performance of CNC machining of a workpiece can be represented by an acoustic signal caused by deformation of the workpiece during machining. Hence, if the acoustic signal can be measured, various classification techniques including machine learning methods can be used to analyze the acoustic signal to estimate a state of the performance of the task and to select appropriate control action for controlling the performance.

The problem, however, faced under this approach is that the acoustic signal does not exist in isolation. For example, in systems including a plurality of actuators actuating one or multiple tools to perform one or multiple tasks, an acoustic signal generated by the tool performing the task is always mixed with signals generated by the actuators actuating the tool. For example, an acoustic signal generated by deformation of a workpiece is always mixed with signals from motors moving a cutting tool. If the acoustic signal could be synthetically generated somehow in isolation or captured somehow in isolation, it would be possible to train a machine learning system such as a neural network to extract such a signal. However, in a number of situations, including CNC machining, such a generation of an isolated signal representing performance of the task is impractical. Similarly, separate recording of different signals by multiple microphones can be impractical as well.

However, some embodiments are based on another recognition that, for certain machines or complex industrial systems, only normal data may be available for training, and domain shift may cause changes in the sound signal unrelated to the presence or absence of anomalous sound. In an example, for a complex industrial system or for a factory automation setting, isolated sounds of every component may not be available. Further, some embodiments are based on the recognition that existing systems for machine sound analysis or sound separation treats recorded sound as being produced by a single machine part.

Some embodiments are based on the realization that most industrial machinery is composed of multiple sound-producing components, and the health of each component may have to be monitored individually. For example, when a machine includes multiple actuators for operating one or more tools and/or performing one or multiple tasks, an audio sound produced by the machine includes a sound of all of these actuators and/or tools. In such a situation, audio source separation could be a useful pre-processing step to isolate the sound from each machine component. Further, the separated sound signals from each component may then be used for, for example, anomalous sound detection or other types of audio monitoring.

Some embodiments are based on recognition that deep-learning-based audio source separation techniques utilize a fully supervised framework. In such techniques, a database of isolated sound signals is used to create artificial mixture signals that the source separation model is trained to separate using the ground-truth isolated signals as targets. However, some embodiments are based on realization that for separating audio signals of machine components (i.e., audio sources), collecting a database of isolated sound signals from individual components may not be possible, as all components of the machine may need to operate simultaneously for the machine to run.

Some embodiments are based on a realization that unsupervised audio separation algorithms are limited to applications when all audio sources to be separated are independent, i.e., have different spectral features. However, the unsupervised audio separation algorithms fail to separate correlated sources, such as music signals.

Some embodiments are based on a realization that beamforming technologies may be used for sound separation for separating multi-channel speech signals in fully supervised setups with oracle information conditioned on source location. For example, beamforming technologies may be used for mapping and measuring sound direction of arrival. In an example, beamforming technologies may be used to obtain a form of array-based measurement, and for sound-source location mapping, specifically from medium to long distances. For example, the location of the source is achieved by estimating an incident angle of amplitudes of plane waves in a specific direction.

However, some embodiments are based on a recognition that such beamforming technology-based sound separation is sub-optimal due to presence of large amounts of noise in an industrial or a factory setting, and the close distances between machine parts we hope to separate. For example, the beamforming technology-based sound separation only enables the slight reduction in background noise without separating the acoustic signals of individual machine parts. Therefore, beamforming technology-based sound separation fails to output isolated sound signals corresponding to every component of a machine in a complex industrial system reliably and accurately.

To overcome the aforementioned drawbacks and enable accurate and reliable sound separation, embodiments of the present disclosure disclose a multi-channel sound separation system. Some embodiments are based on recognizing that a multi-channel spectrogram of an audio mixture carries information on relative locations, i.e., distance and direction, between different audio sources forming the audio mixture and a microphone array measuring the audio mixture. For example, this information can be indicative of inter-channel phase differences of channels in the multi-channel spectrogram of the audio mixture.

Some embodiments are based on recognizing that directional information can be used for separating signals forming an audio mixture that may be produced by a machine. In an example, the machine may include one or more class of components, such as motor, tool, chain, bearing, and other machine parts. To this end, conventional sound separation techniques rely on audio features of a particular class of component to identify and extract an audio signal that may be generated by a particular class of component. However, in industrial settings, heavy-duty machines may include a large number of components, and multiple components belonging to the same class. For example, the machine may include a number of motors, a number of tools, etc. to this end, conventional sound separation techniques fail to separate audio signals that may be generated by different components belonging to a same class, such as different motors of the machine, etc.

Some embodiments are based on an understanding that audio separation for extracting audio signals of individual components (or audio sources) of the machine is useful for anomaly detection. In an example, extracted audio signals belonging to different motors of the machine can be used for anomaly detection of the different motors of the machine. It may be noted that conventional techniques for audio separation fail to identify or separate audio signals of same class of components, such as audio signals from different motors of the machine. Therefore, the conventional techniques for anomaly detection or health monitoring may fail to reliably monitor health or determine anomaly of each of individual components of the machine.

Some embodiments are based on a recognition that spatial location of the audio sources of the machine can be used to identify and extract audio signals belonging to different audio sources of the machine, irrespective of class of the components.

Further, some embodiments are based on an understanding that spatial location information of different audio sources, such as components belonging to same or different classes, is useful for anomaly detection for individual components of the machine.

This is advantageous because audio sources, i.e., components, forming an audio mixture of the operation of the machine often cannot be recorded in isolation. For example, it can be challenging and/or impractical to record a sound of a tool performing a task in isolation from a sound of a motor moving the tool during an operation of the machine. Conversely, the relative locations or spatial locations of the tool and or the actuator of the machines are usually known and thus can be used to facilitate audio signal separation even without having recordings of the isolated sounds forming the mixture.

Some embodiments are based on recognizing the advantages of target phase correlation spectrogram in training a neural network for subsequent audio signals separation. Based on this understanding, some embodiments use the target phase correlation spectrogram as a training target when isolated source signals cannot be collected for training the deep neural network.

Some embodiments are based on the realization that because a structure of a machine is generally known, and the audio sources or components that generate audio signals are generally known as well, it is possible to provide weak labels corresponding to the spatial locations of the audio sources or components that may be producing the audio mixture during the operation of the machine. To that end, some embodiments develop methods that can learn to separate sounds in audio mixtures where training data of the audio mixtures with only weak labels are available.

Accordingly, some embodiments train a neural network to separate from an audio mixture one or more audio signals generated by one or more audio sources, such as tools performing corresponding tasks as well as one or more actuators actuating the tools. For example, the neural network is trained to separate different audio signals from the audio mixture such that each separated audio signal belongs to an audio source having a corresponding relative distance from a microphone array and/or may belong to a different class of signal, in the operation of the machine, while the separated signals sum up to the audio mixture. Weak labels identify the relative location and/or classes of signals present in the operation of the machine.

To that end, to streamline automation for industrial systems, such as monitoring health of each of the components of a machine in an industrial system, there is a need to separate audio signals of each audio source from an audio mixture signal. Accordingly, it is an object of some embodiments to train a neural network for sound separation of audio signals of audio sources forming a mixed signal in the absence of isolated audio signals of such audio sources. As used herein, the audio sources that produce the mixed signal or the audio mixture may occupy different relative location or space in a corresponding environment.

Accordingly, one embodiment discloses an audio system for facilitating an operation of a machine including one or multiple actuators assisting one or multiple tools to perform one or multiple tasks. The audio system comprises an audio input interface configured to receive an audio mixture of signals generated by multiple audio sources including at least one of: the one or multiple tools performing one or multiple tasks, or the one or multiple actuators operating the one or multiple tools. At least one of the audio sources forming the audio mixture is identified by a location relative to a location of each microphone of a microphone array measuring the audio mixture. The audio system comprises a processor configured to extract an audio signal generated by an identified audio source of the multiple audio sources from the audio mixture based on a correlation of spectral features in a multi-channel spectrogram of the audio mixture with directional information indicative of the relative location of the identified audio source. The audio system comprises an output audio interface configured to output the extracted audio signal to facilitate the operation of the machine.

According to an additional system embodiment, the processor is configured to extract the audio signal generated by the identified audio source using a neural network.

According to an additional system embodiment, the spectral features may include inter-channel phase differences of channels in the multi-channel spectrogram of the audio mixture. In an example, the directional information includes target phase differences (TPDs) of a sound propagating from the relative location of the identified audio source to different microphones in the microphone array. Moreover, the correlation of the spectral features and the directional information is represented by a target phase correlation spectrogram. For example, values for different time-frequency bins of the target phase correlation spectrogram quantifies alignment of the inter-channel phase differences with the target phase differences in the corresponding time-frequency bins, and the target phase differences are expected phase differences for the time-frequency bins indicative of properties of sound propagation.

According to an additional system embodiment, the processor is further configured to determine the target phase correlation spectrogram and process the target phase correlation spectrogram with the neural network to extract the audio signal.

According to an additional system embodiment, the target phase correlation spectrogram includes complex numbers, and the neural network is a complex neural network for processing the complex numbers of the target phase correlation spectrogram.

According to an additional system embodiment, the complex neural network has a complex U-net architecture.

According to an additional system embodiment, the complex U-net architecture comprises a complex convolutional encoder, a complex bidirectional long short-term memory network (BLSTM) module arranged to process outputs of the complex convolutional encoder, and a complex convolutional decoder arranged to process the outputs of the complex convolutional encoder and outputs of the complex BLSTM module.

According to an additional system embodiment, the neural network is trained to extract signals of multiple identified audio sources. In an example, the complex U-net architecture includes at least one complex convolutional decoder for each of the identified audio sources.

According to an additional system embodiment, the processor is further configured to determine the target phase correlation spectrogram for the audio mixture using the neural network.

According to an additional system embodiment, to train the neural network, the processor is further configured to receive a training audio mixture of signals generated by one or more audio sources including at least one of: one or more tools performing one or more tasks, or one or more actuators operating the one or more tools. In an example, at least one of the one or more training audio sources forming the training audio mixture is identified by location data relative to the location of each of the microphone array measuring the training audio mixture. The processor is further configured to generate one or more training target phase correlation spectrograms associated with corresponding training audio sources, the one or more training target phase correlation spectrograms being generated based on a correlation between spectral features of the training audio mixture and directional features indicative of the location data of the one or more training audio sources forming the training audio mixture. For example, each time-frequency (TF) bin of the one or more training target phase correlation spectrograms defines a feature that quantifies a match between inter-channel phase differences observed in the spectrogram of the measured training audio mixture and the corresponding expected phase difference indicative of properties of sound propagation for the corresponding location data of the one or more training audio sources relative to the location of each microphone of the microphone array. The processor is further configured to train the neural network to extract training audio signals corresponding to the one or more training audio sources based on the respective one or more training target phase correlation spectrograms. For example, maximizing the target phase correlation for a part at a known location is emphasized as a loss function for neural network training.

According to an additional system embodiment, to train the neural network, the processor is further configured to train the neural network based on a set of loss functions. In an example, the set of loss functions comprise at least one of: a location loss function corresponding to each of the separated training audio signals for the training audio sources, or a reconstruction loss function associated with a summation of the extracted training audio signals for reconstructing the training audio mixture.

According to an additional system embodiment, to compute the location loss functions, the processor is configured to compute ideal target phase correlation spectrogram using physical properties of sound propagation for the one or more training audio sources having associated location data. The processor is further configured to compute estimated training target phase correlation spectrogram associated with corresponding training audio sources. The one or more estimated training target phase correlation spectrograms are generated based on a correlation between spectral features associated with corresponding separated training audio signals and directional features indicative of the location data of the one or more training audio sources forming the training audio mixture. Further, each time-frequency (TF) bin of the one or more estimated training target phase correlation spectrograms defines a feature that quantifies a match between inter-channel phase differences observed in the spectral features of the corresponding separated training audio signals and corresponding expected phase differences indicative of properties of sound propagation for the corresponding location data of the one or more training audio sources relative to location of each microphone of the microphone array. The processor is further configured to determine a difference between the estimated training target phase correlation spectrogram and the corresponding ideal target phase correlation spectrogram for each of the one or more training audio sources, wherein the difference indicates the location loss functions.

According to an additional system embodiment, to train the neural network, the processor is further configured to collect the training audio mixture generated by the one or more training audio sources by moving the microphone array in different locations in proximity to the machine.

According to an additional system embodiment, the processor is further configured to transform the received audio mixture with Fourier transformation to produce a multi-channel short-time Fourier transform (STFT) of the received audio mixture. The processor is further configured to determine inter-channel phase differences (IPDs) between different channels of the multi-channel STFT, determine target phase differences (TPDs) of a sound propagating from the relative location of the identified audio source to different microphones in the microphone array, correlate the IPDs with the TPDs to produce a target phase correlation spectrogram, combine the target phase correlation spectrogram with the multi-channel STFT and frequency position encodings to produce channel concatenation of the received audio mixture, and process the channel concatenation of the received audio mixture with a neural network to extract the audio signal. For example, values of the target phase correlation spectrogram for different time-frequency bins quantifies alignment of the IPDs with the TPDs in the corresponding time-frequency bins, and wherein the TPD is the expected phase difference for the time-frequency bin indicative of properties of sound propagation.

According to an additional system embodiment, to determine the IPDs, the processor is further configured to compare complex values of different channels with a reference channel in the multi-channel STFT to produce inter-channel phase angle differences (IPDs) with respect to a reference microphone in the microphone array. Further, the processor is configured to represent the IPDs as complex numbers. For example, each of the complex numbers have a real part indicative of a cosine of a corresponding phase angle difference from the phase angle differences and an imaginary part indicative of a sine of the corresponding phase angle difference to produce a complex conjugate of each of the represented complex IPDs,

According to an additional system embodiment, to determine the TPDs, the processor is further configured to compute target phase angle differences (TPDs) between when the sound propagating from the identified source in the audio mixture arrives at the different channels with respect to the reference channel based on position values of the machine and microphones in the microphone array. Further, the processor is configured to represent the TPDs as complex numbers. For example, each of the complex numbers have a real part indicative of a cosine of a corresponding target phase angle difference from the produced target phase angle differences and an imaginary part is indicative of a sine of the corresponding expected target phase angle difference to produce a complex conjugate of each of the represented complex TPDs.

According to an additional system embodiment, to determine the target phase correlation spectrogram, the processor is configured to compute products for each of the complex conjugates of the complex IPDs and the corresponding complex conjugates of the complex TPDs for each time-frequency bin and determine a sum of each of the products over all non-reference channels.

According to an additional system embodiment, the processor is further configured to produce a control command for the operation of the machine based on the extracted signal and transmit the control command to the machine over a communication channel.

According to an additional system embodiment, the processor is further configured to analyze the extracted audio signal generated by the identified acoustic source from the audio mixture to produce a state of performance of a task, select the control command from a set of control commands based on the state of performance of the task, and cause the machine to execute the control command. In an example, the set of control commands correspond to different states of performance of the one or multiple tasks.

According to an additional system embodiment, the processor is further configured to determine an anomaly score for the identified acoustic source based on the extracted audio signal corresponding to the identified audio source. In an example, the anomaly score indicates a correlation between a type of an anomaly and a state of the identified acoustic source. The processor is further configured to compare the anomaly score with an anomaly threshold, select the control command from a set of control commands to be performed by the machine when the anomaly score is greater than the anomaly threshold, and transmit the selected control command to the machine for overcoming the anomaly at the identified acoustic source.

Another embodiment discloses a system for facilitating an operation of a machine including one or multiple actuators assisting one or multiple tools to perform one or multiple tasks. The system comprises a processor and a memory having instructions stored thereon that cause the processor to receive an audio mixture of signals generated by multiple audio sources including at least one of: the one or multiple tools performing the one or multiple tasks, or the one or multiple actuators operating the one or multiple tools, extract an audio signal generated by an identified audio source of the multiple audio sources from the audio mixture based on a correlation of spectral features in a multi-channel spectrogram of the audio mixture with directional information indicative of the relative location of the identified audio source, and output the extracted audio signal to facilitate the operation of the machine. In an example, at least one of the audio sources forming the audio mixture is identified by a location relative to a location of each microphone of a microphone array measuring the audio mixture.

Yet another embodiment discloses a method for facilitating an operation of a machine including one or multiple actuators assisting one or multiple tools to perform one or multiple tasks. The method comprises receiving, using an audio input interface, an audio mixture of signals generated by multiple audio sources including at least one of: one or a combination of one or multiple tools performing one or multiple tasks, or one or multiple actuators operating the one or multiple tools. For example, at least one of the audio sources forming the audio mixture is identified by a location relative to a location of each microphone of a microphone array measuring the audio mixture. The method comprises extracting, using a processor, an audio signal generated by an identified audio source of the multiple audio sources from the audio mixture based on a correlation of spectral features in a multi-channel spectrogram of the audio mixture with directional information indicative of the relative location of the identified audio source. The method comprises outputting, using an output audio interface, the extracted audio signal to facilitate the operation of the machine.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of an environment in which an audio system for extracting an audio signal from an audio mixture is implemented, according to an example embodiment.

FIG. 2A illustrates a flow diagram illustrating an input for a neural network of the audio system for the audio signal extraction, according to an example embodiment.

FIG. 2B illustrates a block diagram of the audio system for extracting audio signal from an audio mixture during operation of a machine, and using the extracted signal for subsequent monitoring tasks, according to some embodiments.

FIG. 3A illustrates a machine that may generate the audio mixture, according to an example embodiment.

FIG. 3B illustrates a spectrogram of the audio mixture of signals generated by the machine performing a task, according to some embodiments.

FIG. 4A and FIG. 4B show example illustrations of a phase angle difference in a microphone array used for computing the target phase angle difference (TPD) and corresponding IPD, respectively, according to some embodiments.

FIG. 5A and FIG. 5B show example illustrations of an ideal target phase correlation spectrogram and a computed target phase correlation spectrogram, respectively, according to some embodiments.

FIG. 6A illustrates an example flowchart for training the neural network for extracting audio signals corresponding to audio sources, according to some embodiments.

FIG. 6B illustrates an example of gathering training audio mixture, according to some embodiments.

FIG. 6C illustrates an example of training the neural network based on a set of loss functions, according to some embodiments.

FIG. 6D illustrates an example flow diagram illustrating computation of location loss function for training the neural network, according to some embodiments.

FIG. 7A illustrates a network architecture of the neural network, according to some embodiments.

FIG. 7B illustrates a flow diagram illustrating computation of input features for the neural network, according to some embodiments.

FIG. 7C illustrates a flow diagram illustrating computation of target phase correlation spectrogram for the extracting audio signal, according to some embodiments.

FIG. 8 illustrates a schematic diagram illustrating controlling machining operations based on anomaly detection, according to some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

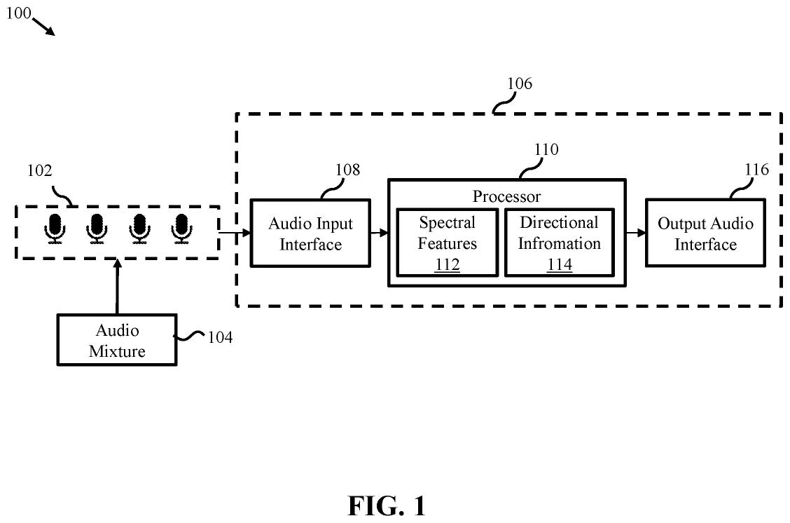

FIG. 1 shows a block diagram of an environment 100 in which an audio system 106 for extracting an audio signal from an audio mixture 104 is implemented, according to some embodiments. For example, the audio system 106 is configured to separate audio signals corresponding to different audio sources that collectively produce the audio mixture 104 during operation of a machine. The separated audio signals may be used for analyzing performance and controlling the operation of the machine, according to some embodiments.

In an embodiment, a microphone array 102 may be an array of multiple microphones configured to measure the audio mixture 104. In particular, the microphone array 102 may include multiple microphones (for example, two or more microphones) to record sound. The microphones in the microphone array 102 may work together to record sound simultaneously. For example, the microphones of the microphone array 102 may be similarly matched to ensure uniform and even sound recordings. In an example, the microphone array 102 may be configured to measure the audio mixture 104 generated by the machine during its operation.

In an example, the microphone array 102 captures the audio mixture 104 produced by individual actuators and/or the tools of the machine during the operation of the machine. In some cases, some of the actuators or the tools may not operate individually. For example, an actuator assisting operation of a tool in performing a task may only operate together, i.e., when in conjunction. Subsequently, audio signals generated by the actuator, the tools and/or the performance of the task may only be captured together by the microphone array 102. Therefore, the audio mixture 104 captured by the microphone array 102 is an acoustic mixture, composed of a sum of the audio signals produced by different components of the machine performing one or more tasks. In some embodiments, at least some of the audio signals in a spectrogram of the audio mixture 104 may occupy same time, and frequency spectrum.

In an example, certain conventional sound separation techniques may be able to separate sound based on audio characteristics, such as frequency. For example, different classes of audio sources may produce audio signals having different audio characteristics (for example, different musical instruments or different people may produce audio signals with different audio characteristics). To this end, based on identification of audio characteristics of different class of audio sources when the different audio sources operate in isolation (such as audio characteristics of different musical instruments operating in isolation) and knowledge of class of components producing an audio mixture, audio signals belonging to different audio sources may be separated.

However, in certain cases, it may not be possible to know audio characteristics of an audio source in isolation. For example, isolated audio signals from, for example, different components of a machine that must run simultaneously in order for the machine to function, cannot be recorded in isolation. Therefore, isolated signals for each component may be unavailable and may hinder training of neural networks for audio signal separation or extraction.

Further, the problems of audio source separation are aggravated due to unavailability of isolated signals of different components of machine and presence of plurality of same type or class of components (such as presence of two or more motors or two or more actuators) in the machine. In such cases, it becomes challenging to extract an audio signal produced by a particular audio source from an audio mixture as separate audio sources cannot be recorded in isolation and multiple audio signals may have same or similar audio characteristics.

In practice, most industrial machinery may be composed of multiple sound-producing components, and the health of each component may have to be monitored individually. In these situations, separated or isolated audio signals from each component may be required for downstream processing, such as anomalous sound detection or other types of audio monitoring. Once the audio signals for different audio sources of the machine are isolated from the audio mixture 104, such audio signals may be used for estimating a state of performance, health, and execution of task of corresponding audio source.

Some embodiments of the present disclosure are based on an understanding that the presence of the microphone array 102 and knowledge of locations of the audio sources, i.e., the components, of the machine relative to a location of the microphone array 102 is known. In an example, the relative locations of the audio sources may be determined based on schematics of the machine and/or an environment where the machine is positioned or based on sensor data from image sensors. To this end, the audio sources forming the audio mixture 104 may be identified by a corresponding location (referred to as audio source locations) relative to a location (referred to as microphone array location, hereinafter) of the microphone array 102 measuring the audio mixture 104.

Some embodiments of the present disclosure are based on a realization that locations of the audio sources may be used as weak labels for learning to separate the audio signals from the different audio sources.

Some embodiments are based on an understanding that audio source locations relative to the microphone array location are useful for anomaly detection within the audio sources.

In an example, the audio system 106 may include an audio input interface 108 configured to receive the audio mixture 104 of signals generated by multiple audio sources of the machine. For example, various components of the machine may produce sound, such as during controlling, performing task, etc. In some cases, a combination of components of the machine may produce sound, for example, an actuator assisting a tool to perform a task may produce a sound in combination. To this end, various components, individually or in combination, producing sound may correspond to plurality of audio sources of the machine.

The audio system 106 may include a processor 110 configured to extract an audio signal generated by an identified audio source from the audio mixture 104. For example, the identified audio source may be a pre-selected audio source from the plurality of audio sources of the machine, or the identified audio source may be selected randomly. The audio input interface 108 may provide the audio mixture 104 to the processor 110 for extraction of the audio signal of the identified audio source. Further, the processor 110 may be configured to extract spectral features 112 of the audio mixture 104. The processor 110 is also configured to determine directional information 114 relating to the audio sources producing the audio mixture 104. For example, the spectral features 112 may indicate a multi-channel spectrogram of the audio mixture 104; and the directional information 114 may indicate relative location of the identified audio source. Further, the audio signal for the identified audio source is separated based on a correlation of the spectral features 112 of the audio mixture 104 and the directional information 114 of the identified audio source.

In an example, identification of different audio sources, irrespective of a class of the audio sources may be performed using the directional information 114. Such direction information 114 may provide spatial location information of the audio sources relative to a location of the microphone array 102. This enables audio separation in cases where isolated audio signals of audio sources are unavailable as well as cases where there may be multiple audio sources belonging to the same sound class, say motors, actuators, etc.

In an example, the audio system 106 includes a neural network configured to isolate or extract the audio signal produced by the identified audio source from the audio mixture 104. Once the audio signal for the identified audio source and/or all the audio sources are isolated and extracted from the audio mixture 104, they may be used for monitoring and/or controlling operations of the machine.

Further, the audio system 106 may include an output audio interface 116 configured to output the extracted audio signal to facilitate the operation of the machine. For example, the extracted audio signal may be rendered or played for further analysis, such as anomaly detection, determining condition of the identified audio source, determining state of performance of task performed by the identified audio source, etc. To this end, in one example, the extracted audio signal may be rendered as a playback audio, for example, for analysis of health of the identified audio source. In another example, the extracted audio signal may be provided to a downstream processing system that may be used for analyzing the extracted audio signal.

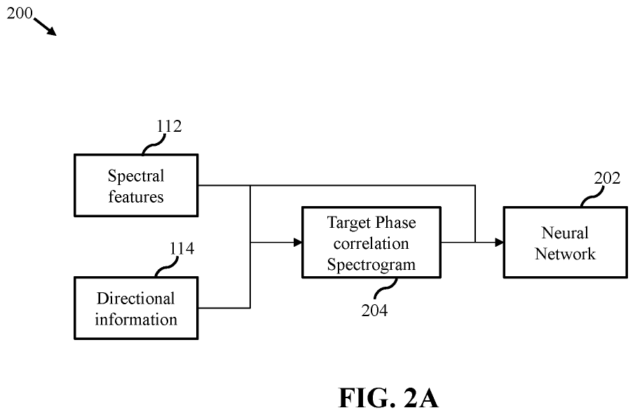

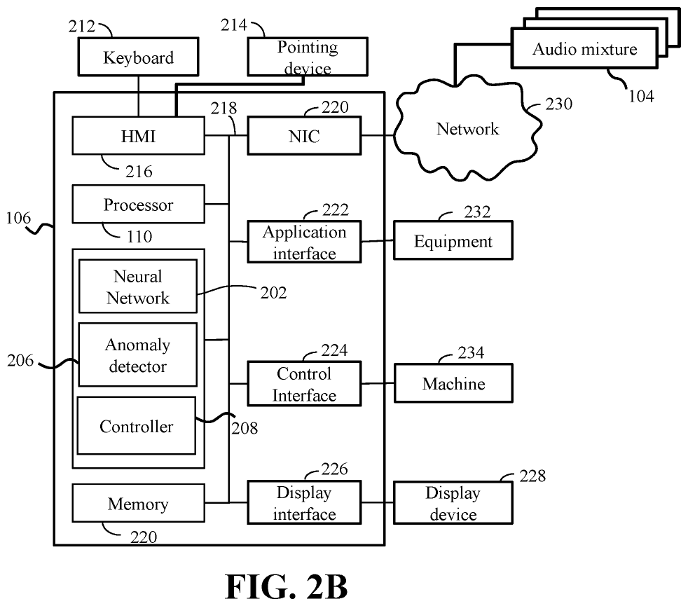

FIG. 2A shows a flow diagram 200 illustrating an input for a neural network 202 for audio signal extraction, according to some embodiments. In an example, the neural network 202 may be configured to extract an audio signal that may be generated by the identified audio source from the different audio sources of a machine.

In an example, the neural network 202 is configured to extract the audio signal from the audio mixture 104 based on a correlation of spectral features 112 with directional information 114 of the relative location of the identified audio source. As may be noted, the spectral features 112 may be frequency-based features in a multi-channel spectrogram of the audio mixture 104. As the audio mixture 104 is recorded with multiple microphones of the microphone array 102; thus, multi-channel spectrograms of the audio mixture 104 are extracted from a same signal recorded with different microphones. For example, the spectral features 112 may be obtained by converting a time-based signal of the audio mixture 104 into the frequency domain using, for example, Fourier Transform. In an example, the spectral features 112 may indicate, for example, fundamental frequency, frequency components, spectral centroid, spectral flux, spectral density, spectral roll-off, etc.

In one example, the spectral features 112 include inter-channel phase differences (IPDs) of channels in the multi-channel spectrogram of the audio mixture 104. Inter-channel phase difference (IPD) refers to a phase offset or a phase shift between audio signals of different channels in a multi-channel audio system, i.e., the multiple channels of microphones in the microphone array 102. In an example, the IPDs of the multi-channel spectrogram may indicate a difference in timing or alignment of waveforms between two or more audio channels or microphones. These timing differences between microphones of the microphone array 102 indicated by the IPD may provide information about where an audio source is physically located, since sound waves will arrive at the different microphones at different times depending on the physical location of the identified audio source.

Further, the directional information 114 may indicate relative distance and relative direction between each of the microphones of the microphone array 102 and the different audio sources. In an example, the directional information 114 may include target phase differences (TPDs) of a sound propagating from the relative location of the identified audio source to different microphones in the microphone array 102.

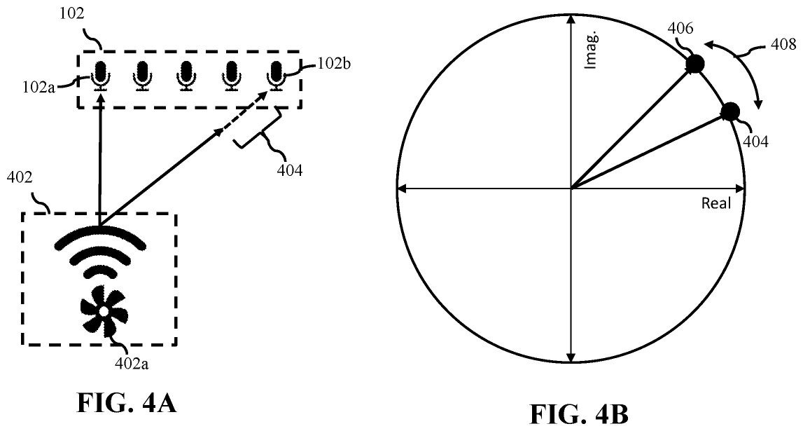

In one example, the TPDs correspond to the expected time delays of a sound propagating from the identified audio source location to the multiple channels of the microphone array 102. The TPDs refer to desired, ideal, or expected phase relationships between different audio channels or elements within the multiple channels of the microphone array 102. For the identified audio source at a known physical location relative to the microphone array 102, the TPDs correspond to the IPDs that may be expected to be received from the identified audio source at the known physical location given properties of sound propagation. Details of a TPD are described in conjunction with, for example, FIG. 4A.

Continuing further, the TPDs may be correlated with the IPDs to produce a target phase correlation spectrogram 204. In an example, the correlation of the spectral features 112 and the directional information 114 is represented by the target phase correlation spectrogram 204. When correlating IPDs (Inter-Channel Phase Differences) and TPDs (Target Phase Differences) in audio, actual phase relationships of the audio mixture 104 over the audio channels may be compared with the intended or desired phase relationships of the different channels of the multiple channels of the microphone array 102.

For example, IPDs may indicate the measured or actual phase differences between different audio channels, such as the phase difference between the multiple microphones in the microphone array 102 due to spatial difference in the locations of the multiple microphones and the audio sources of the machine. Further, TPDs may indicate the target or ideal phase relationships for audio sources of the machine, such as specific phase differences that may be ideally present due to relative locations of the audio sources. In an example, the IPDs and the TPDs may be complex numbers.

In an example, by comparing or correlating the measured IPDs with the intended TPDs, the target phase correlation spectrogram 204 may be generated. For example, the target phase correlation spectrogram 204 may indicate whether the actual or measured phase relationships align with the target phase relationships corresponding to the TF bins. If the IPDs closely match the TPDs, it indicates that there is a single audio source observed by the microphone array 102 and its position is the physical location used to compute the TPDs. If there are significant deviations, it could mean that the IPDs are computed from an audio mixture signal as opposed to a single audio source. Details of correlating the IPDs with the TPDs are further described in conjunction with, for example, FIG. 4B.

Further, values for the different time-frequency (TF) bins of the target phase correlation spectrogram 204 may quantify alignment of the IPDs with the target phase differences in the corresponding time-frequency bins, i.e., TF bins of the target phase correlation spectrogram 204 may quantify alignment of the IPDs with TPDs for associated TF bins. Moreover, the TPDs may be the expected phase differences or expected phase relationships for the corresponding TF bins and the expected value for the corresponding IPD given a specific source location. To this end, the target phase correlation spectrogram 204 may refer to a visual representation or analysis of the phase relationships between different audio channels over time, based on the expected phase relationships.

In an example, the target phase correlation spectrogram 204 may be determined based on a correlation or comparison of the measured phase difference across the multiple channels of the microphone array 102 or IPDs of the audio mixture 104 with the expected or target phase difference of the identified audio source. In an example, a TF bin of the target phase correlation spectrogram 204 defines a feature that quantifies how well the phase differences observed in the measured spectrograms or the spectral features 112 (i.e., the inter-channel phase differences or IPDs) match the directional information 114 or the expected phase differences (i.e., the target phase differences or TPDs). For example, when the measured IPDs are correlated with a TPD corresponding to a given source location of the identified audio source, such as a source location of a component of the machine, TF bins with IPDs well matched to the TPD are emphasized and/or utilized by the neural network 202 for separating audio signal that may be generated by the identified audio source.

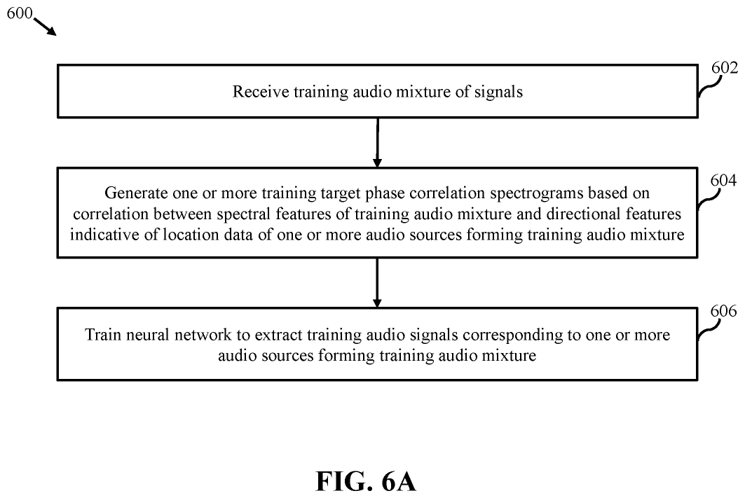

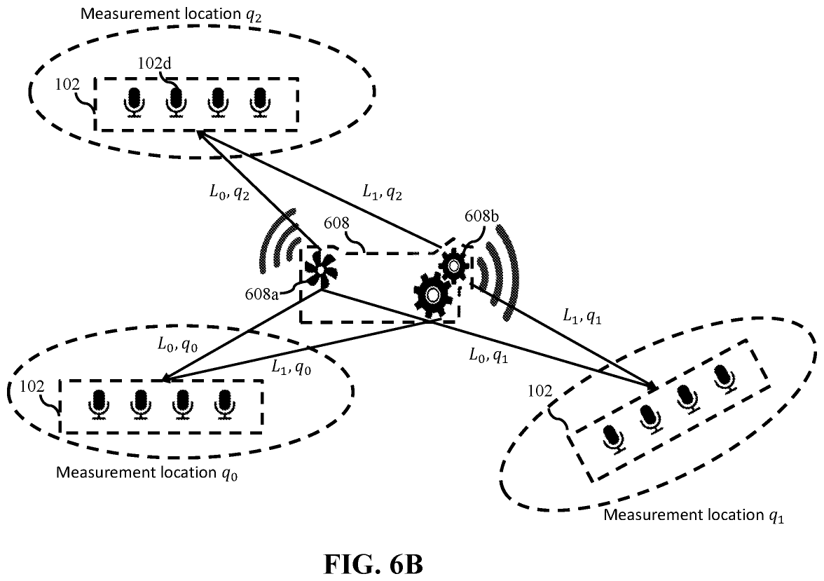

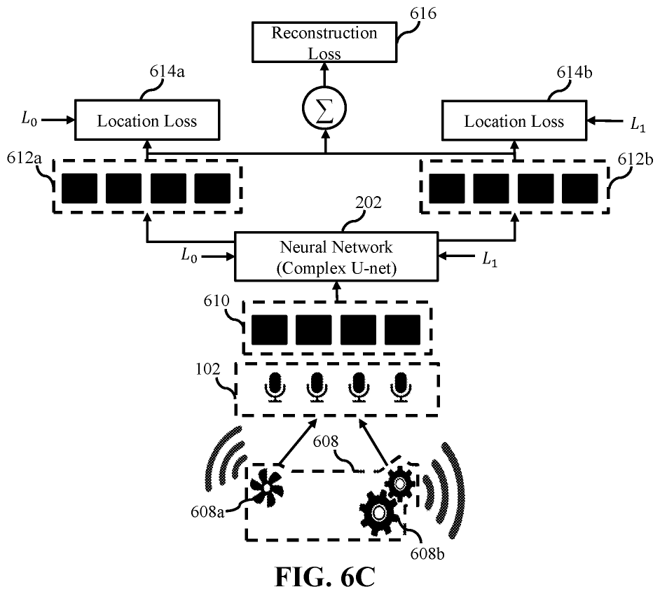

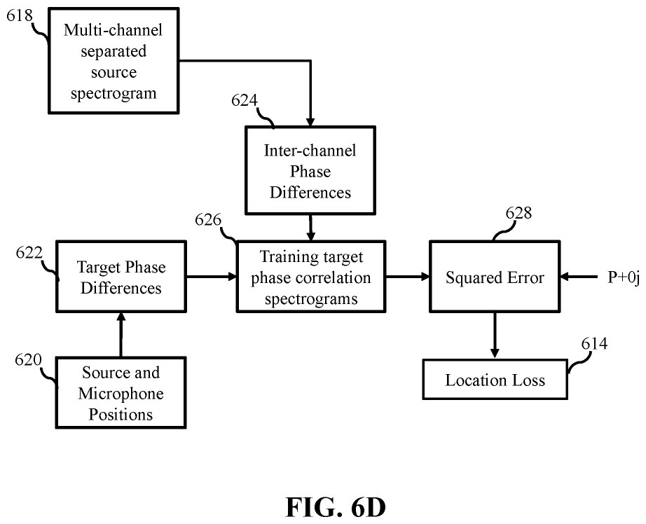

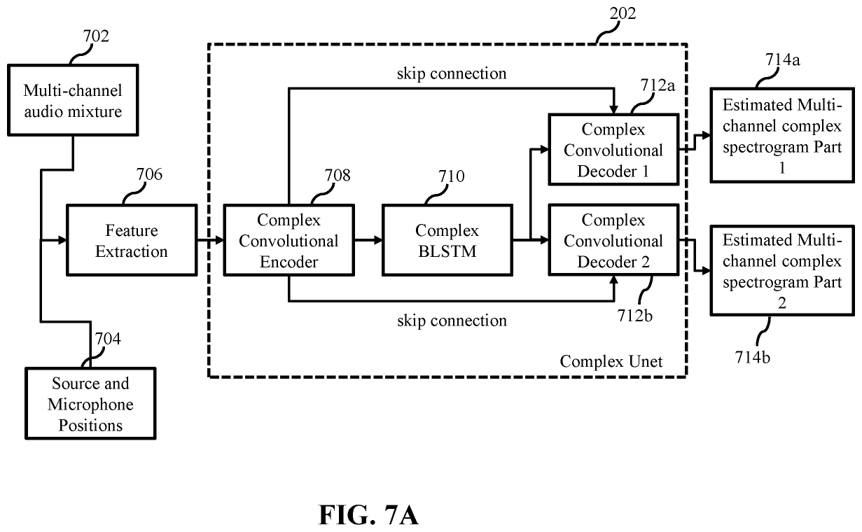

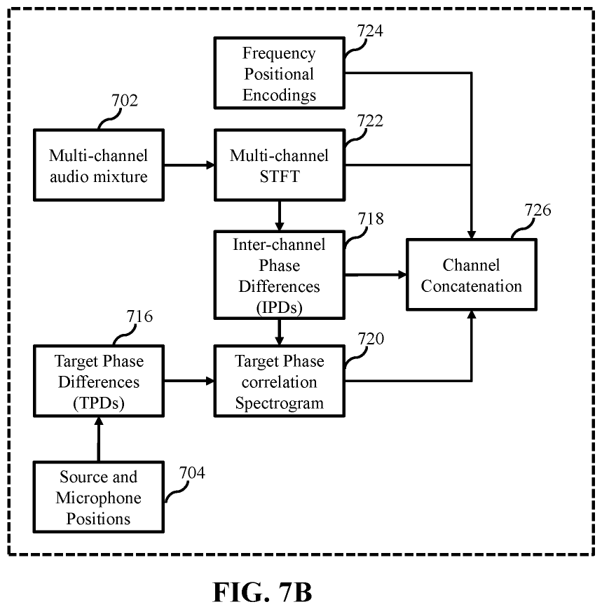

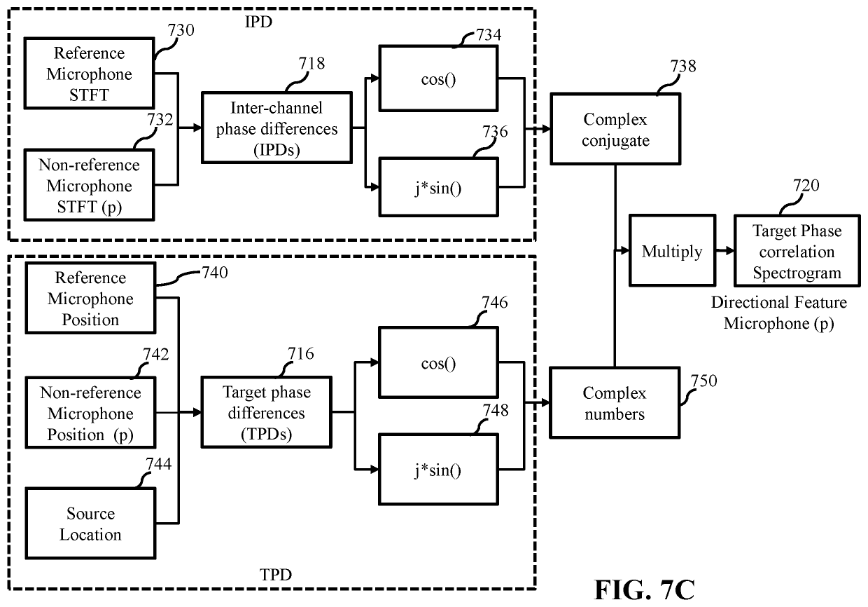

Further, for extraction of the audio signal that may be generated by the identified audio source, the target phase correlation spectrogram 204 along with the measured spectral features 112 may be provided to the neural network 202. The target phase correlation spectrogram 204 may be processed with the neural network 202 to extract the audio signal corresponding to the identified audio source. The presence of the target phase correlation spectrogram 204 as input to the neural network 202 is crucial to have any separation from the audio mixture 104. Otherwise, the neural network 202 may have no other conditioning mechanism to inform it on which source location we want to separate. Details of training of the neural network 202 are described in conjunction with, for example, FIGS. 6A-6D; and a manner in which the neural network 202 utilizes the target phase correlation spectrogram 204 to extract audio signal of the identified audio source is described in detail in conjunction with, for example, FIG. 7A, FIG. 7B, and FIG. 7C.

FIG. 2B shows a block diagram of the audio system 106 for extracting audio signal from the audio mixture 104 during operation of a machine 234. The audio system 106 may be configured to use the extracted audio signal for subsequent monitoring tasks, according to some embodiments.

In an example, the audio system 106 may receive the audio mixture 104 from the microphone array 102, via a network 230. For example, the processor 110 may be configured to process the audio mixture 104.

To this end, the audio system 106 may include various modules executed by the processor 110 to process the audio mixture 104 and control the operation of the machine 234. The processor 110 may process the audio mixture 104 of signals using a neural network 202 to extract the audio signal generated by an identified audio source, say a tool performing a task, from the audio mixture 104 of signals. For example, the processor 110 may be configured to analyze the extracted audio signal using an anomaly detector 206 to identify an anomaly in the identified audio source and/or a state of performance of the task performed by the identified audio source. In certain cases, the processor 110 may be configured to transmit a control command selected by a controller 208 according to the anomaly and/or the state of performance of the task to the machine 234. For example, the selected control command may be communicated through a control interface 224 to the machine 234 for applications such as avoiding faults and maintaining smooth operation in the machine 234.

The audio system 106 may have a number of input 108 and output 116 interfaces connecting the audio system 106 with other systems and devices. For example, a network interface controller (NIC) 220 is adapted to connect the audio system 106 through the bus 218 to the network 230. Through the network 230, either wirelessly or through the wires, the audio system 106 may receive the audio mixture 104 as input signal. In some implementations, a human machine interface (HMI) 216 within audio system 106 connects the audio system 106 to a keyboard 212 and a pointing device 214, wherein the pointing device 214 may include a mouse, a trackball, a touchpad, a joystick, a pointing stick, a stylus, or a touchscreen, among others. Through the HMI 216 or the NIC 220, the audio system 106 may receive data, such as the audio mixture 104 produced during the operation of the machine 234.

The audio system 106 includes the output interface 116 configured to output the separated acoustic signals corresponding to the different audio sources forming the audio mixture 104 produced during the operation of the machine 234. In an example, the output interface 116 may also output an output of the anomaly detector 206 and/or the controller 208, i.e., an anomaly score of an audio source of the machine 234 and/or a control command for the audio source of the machine 234. For example, the output interface 116 may include a memory to store and/or output the separated audio signals or anomaly detector results. For example, the audio system 106 may be linked through the bus 218 to a display interface 226 adapted to connect the audio system 106 to a display device 228, such as speakers, headphones, a computer monitor, a camera, a television, a projector, or a mobile device, among others. The audio system 106 may also be connected to an application interface 222 adapted to connect the audio system 106 to equipment 232 for performing various operations.

The audio system 106 includes the processor 110 configured to execute stored instructions, as well as the memory 210 that stores instructions that are executable by the processor 110. The processor 110 may be a single core processor, a multi-core processor, a computing cluster, or any number of other configurations. The memory 210 may include random access memory (RAM), read only memory (ROM), flash memory, or any other suitable memory systems. The processor 110 is connected through the bus 218 to one or more input and output devices. These instructions implement a method for extracting audio signals produced during operation of the machine 234 for, for example, anomaly detection, performance estimation and future control.

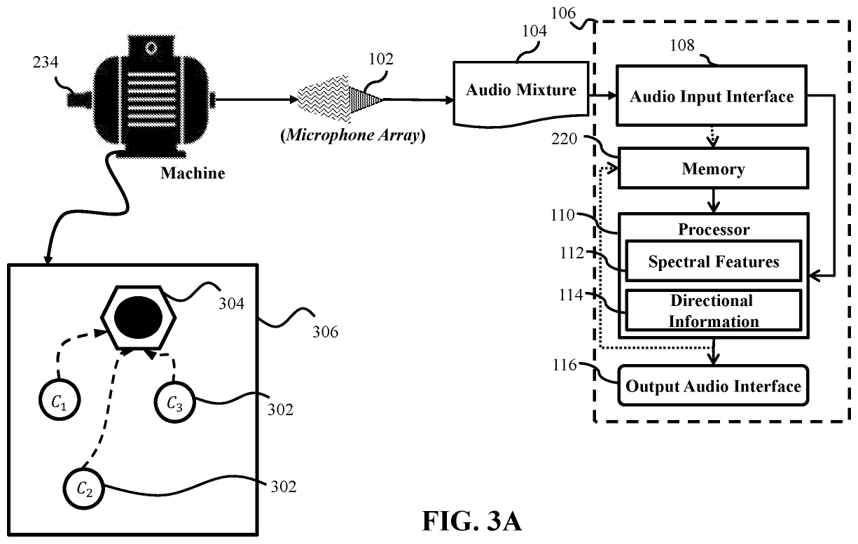

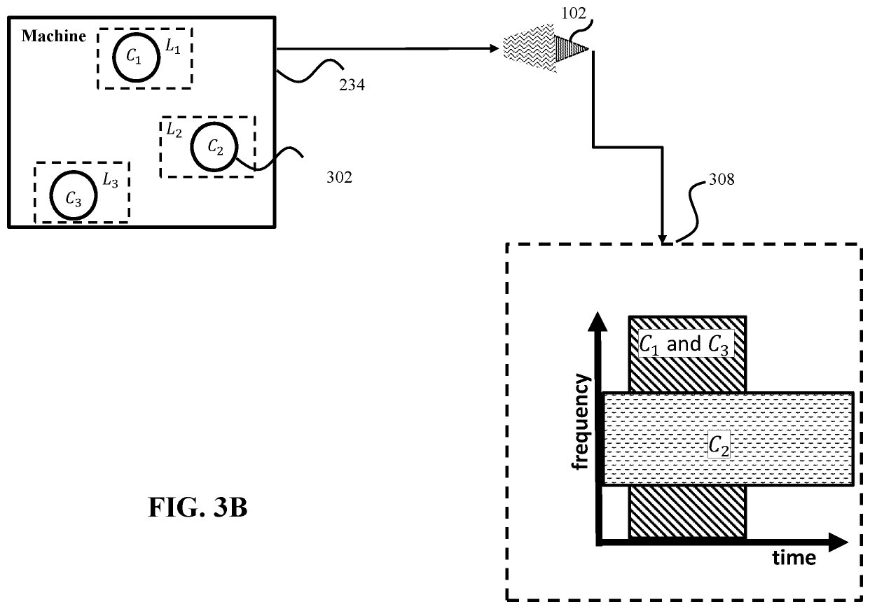

FIG. 3A shows a machine 234 that may generate the audio mixture 104. In an example, the machine 234 may include one or multiple actuators 302 (depicted as actuators C₁, C₂, and C₃) connected to and/or assisting one or multiple tools (depicted as tool 304). For example, the tool 304 may be configured to perform one or multiple tasks associated with the operation of the machine 234. Examples of the tasks performed by the actuators 302 and/or the tools 304, such as in combination, may include, for example, machining, cutting, soldering, assembling, controlling motion, etc. In some embodiments, the actuators 302 and the tool 304 may operate simultaneously and/or in a particular combination. For example, the actuators 302 may assist and/or control the tool 304 individually or in a combination. For example, in some embodiments, the audio system 106 controls an operation of the machine 234 including the actuators 302 assisting the tool 304 to perform the one or multiple tasks, based on extracted audio signals corresponding to individual audio sources, i.e., the actuators 302 and the tool 304.

In an example, the multiple audio sources of the machine 234 may include, for example, one or combination of the tool 304 performing one or multiple tasks and the actuators 302 operating the tool 304. In particular, any of the actuators 302 and/or the tool 304 may produce sound, either together or in some combination. Therefore, such actuators 302 and the tool 304, together or in some combination, may form the audio sources of the machine 234. For example, the audio sources, i.e., the actuators 302 and/or the tool 304, may produce the audio mixture 104.

For example, the actuators 302 and/or the tool 304, during the performance of tasks, may generate corresponding audio signals. Therefore, the actuators 302 and the tool 304 may correspond to audio sources generating corresponding audio signals. To this end, a summation of the audio signals produced by each of the audio sources, i.e., the actuators 302 and the tool 304, may form the audio mixture 104.

In an example, the microphone array 102 may measure different audio signals produced by the machine 234, i.e., different components of the machine 234 during their operation. A summation of the such audio signals may form the audio mixture 104. For example, the microphone array 102 may provide the audio mixture 104 to the audio system 106, specifically the audio input interface 108. In certain cases, the audio system 102 may include memory 210, such that the audio input interface 108 may cause to store the received audio mixture 104 within the memory 210. Further, the audio input interface 108 may provide the audio mixture 104 to the processor 110 for processing and extraction or separation of an audio signal of an identified audio source, say audio signal of actuator C₃. In certain cases, the processor 110 may store the extracted audio signal within the memory 210. Further, the output audio source 116 may be configured to render, output or play the extracted audio signal. In an example, the output audio source 116 may retrieve the extracted audio signal from the memory 210 for outputting. In certain other cases, the output audio source 116 may provide the extracted audio signal of the identified audio source for downstream processing, such as anomaly detection, health inspection, etc. To this end, use of the extracted audio signal using the neural network 202 enables accurate association of separated audio signal with its corresponding audio source. Moreover, in this regard, anomaly detection using accurately mapped audio signals to corresponding audio sources also enables increased accuracy of anomaly detection.

Pursuant to embodiments of the present disclosure, spatial location information corresponding to audio sources of the machine 234 may be utilized to extract audio signals associated with individual audio sources. In this regard, in an example, the processor 110 may be configured to generate a location map 306 indicating spatial information for the several audio sources, i.e., the actuators 302 and the tool 304. In an example, the location map 306 may be generated with the help of known schematic of the machine 234, known schematic of an environment in which the machine 234 is placed, and/or based on sensor data. In one example, sensors, such as image sensors or cameras may be used to scan the environment in which the machine 234 is placed. Further, based on the scanning of the environment, different components may be identified. In certain cases, certain user input may be requested, for example, from users operating the machine 234, in order to accurately identify the components, i.e., the actuators 302 and the tool 304, of the machine 234.

To this end, every known component of the machine 234 may be marked or labeled with a corresponding location data. Such location data may be relative location of the component with respect to the location of each microphone of the microphone array 102 in the environment.

Further, the directional information 114 of the audio sources of the machine 234 may be extracted based on the location map 306 of the machine 234. It may be noted that such directional information 114 of the audio sources is crucial in separating audio signals belonging to different audio sources from the audio mixture 104.

Referring to FIG. 3B, there is shown a spectrogram 308 of the audio mixture 104 of signals generated by the actuators 302 of the machine 234 performing a task, according to some embodiments. The spectrogram 308 may depict a time-frequency representation of a sound signal. In other words, the spectrogram 308 may show acoustic characteristics of the audio signals from the audio sources C₁ C₂ and C₃ forming the audio mixture 104. It may be noted that the spectrogram 308 of the audio mixture 104 is only shown for a single microphone in the microphone array 102. The spectrograms of the other microphones look similar, but may have phase shifts caused by delays between the microphones. In an example, when the multiple actuators 302 may belong to a same class of audio sources, they may produce sound signals with similar characteristics that may fully overlap on the spectrogram 308 as shown by C₁ and C₃ in FIG. 3B. In this situation directional or spatial information from the microphone array 102 corresponding to the acoustic sources C₁-C₃, will be used such that different audio signals belonging to same class of the audio sources C₁-C₃, i.e., actuators 302, may be distinguished using the neural network 202.

For example, the audio mixture 104 may be generated by the actuators 302 actuating the tool 304, as well as the tool performing a task. However, for ease of depiction and explanation, acoustic characteristics of the actuators 302 are shown in the spectrogram. This should not be considered as a limitation. The audio mixture 104 may also include audio signal produced by the tool 304.

Some embodiments are based on a realization that it is possible to isolate audio signals from different audio sources by identifying characteristics of sound produced by each audio source individually. For example, the machine 234 includes actuators 302 indicated by C₁-C₃, and the audio signals produced by each audio source may be isolated when characteristics of sound produced by each of the actuators 302 in isolated condition is known. However, as certain components of the machine 234 always operate in coherence, for example, the actuators C₁ and C₂ may assist in operation of the tool 304 together and may operate together, therefore characteristics of isolated sound of each component, i.e., C₁-C₃, may not be known.

Further, in an audio mixture produced during operation of the machine 234, different audio signals produced by different audio sources of the machine 234 may overlap in, for example, time and frequency, as shown in the spectrogram 308. Pursuant to the present example, the audio characteristics of the audio signals produced by the actuators 302 may be similar. For example, frequencies of the audio signals produced by the actuators 302 may be similar. Therefore, audio signals may not be separated by conventional techniques.

To that end, to streamline operation of the machine 234 including the actuators 302 actuating the tool 304 to perform one or multiple tasks, there is a need to separate audio signals from the audio mixture 104 of signals generated by combination of different audio sources while performing a task. Accordingly, it is an object of some embodiments to train a neural network for sound separation or audio signal extraction for different audio sources producing the audio mixture 104 in the absence of isolated sound of each audio source.

In some situations, at least some of the audio sources occupy the same time and/or frequency spectrum in the spectrogram 308 of the audio mixture 104. For example, in one embodiment, the audio sources C₁-C₃ forming the audio mixture 104 may occupy different regions in an environment, such as a room. To this end, as shown in the spectrogram 308, when time frequency characteristics are insufficient to isolate the sound, spatial or location information corresponding to the actuators 302 may be identified. For example, location L₁ is identified corresponding to the actuator C₁, location L₂ is identified corresponding to the actuator C₂ and location La is identified corresponding to the actuator C₃. Additionally, the acoustic mixture 104 may be measured from only multiple microphones, i.e., multiple channels, of an output of the microphone array 102. In this regard, the multiple channels of the microphone array 102 may receive the audio mixture differently. Subsequently, the location information L₁, L₂, and L₃ may be used for audio signal separation.

Some embodiments are based on recognizing that a multi-channel spectrogram of the audio mixture 104 carries information on relative locations between different audio sources forming the audio mixture 104 and the microphone array 102 measuring the audio mixture 104. For example, this information can be indicative of inter-channel phase differences (IPDs) of channels in the multi-channel spectrogram of the audio mixture 104.

Some embodiments are based on recognizing that such relative location information can be used for separating signals forming the audio mixture 104 to facilitate an operation of the machine 234. This is advantageous as audio sources forming the audio mixture 104 of the operation of the machine 234 often cannot be recorded in isolation. For example, it may be challenging and/or impractical to record a sound of the tool 304 performing a task in isolation from a sound of the actuators 302 or a motor operating or assisting the tool 304. Conversely, the relative locations of the tool 304 and/or the actuators 302 of the machine 234 may be known and thus can be used to facilitate audio signals separation even without having recordings of the isolated sounds forming the audio mixture 104.

Some embodiments are based on the realization that because the relative locations of the tool 304 and/or the actuators 302 of the machine 234 is known, it is possible to use location information as labels for the audio sources of the audio mixture representing an operation of the machine, even when sound signals are fully overlapped in time and frequency such as C₁ and C₃ in FIG. 3B. To that end, some embodiments provide techniques to separate sounds from audio mixtures where training data of the acoustic mixtures when only weak labels based on audio source location are available.

Accordingly, some embodiments train the neural network 202 to separate from the audio mixture 104 an audio signal generated by an identified audio source. For example, the neural network 202 may be trained to separate different audio signals from the audio mixture 104 such that each separated audio signal belongs to an audio source present in the operation of the machine 234, while the separated audio signals sum up to the audio mixture 104. Weak labels identify the relative locations of the audio sources producing audio signals present in the operation of the machine 234.

Referring to FIG. 4A, there is an example illustration of a phase angle difference in the microphone array 102 used for computing a target phase angle difference (TPD) 404, according to an embodiment. As may be noted, the directional information, i.e., target phase correlation (TPD) may be computed for a single microphone pair, i.e., 102a and 102b, of the microphone array 102 at a single time-frequency bin. However, such depiction of the microphone pair 102a and 102b is only exemplary and should not be construed as a limitation.

FIG. 4A illustrates an example machine 402 having a component 402a, such as an actuator or a tool, for producing a sound. Such component 402a may be an audio source. It may be noted that the machine 402 depicted to have a single component 402a is only exemplary and should not be construed as a limitation. The machine 402 may include other components.

With regard to the component 402a, the TPD 404 for a sound generated by the component 402a may be computed based on the microphone pair 102a and 102b, In particular, the TPD 404 for the component 402a corresponds to a time difference between when the sound arrives at a reference microphone, say the microphone 102a in the microphone array 102, and when it arrives at a non-reference microphone, say the microphone 102b in the microphone array 102. To this end, the TPD 404 is computed using properties of sound propagation between the known locations of each audio sources, i.e., the component 402a, to be separated, and the known locations of each microphone, i.e., the microphones 102a and 102b, in the microphone array 102. Specifically, the time difference depends on the frequency value of the time-frequency bin for which we are computing the TPD and the speed of sound.

In an example, the TPD may be computed with different microphone pairs at the same or different TF bins. For example, the different microphone pairs may include the reference microphone 102a and any other non-reference microphone of the microphone array 102. Such TPDs may indicate target, ideal or expected phase differences in propagation of the sound produced by the component 402a across the different microphones (i.e., channels) of the microphone array 102.

Further, FIG. 4B illustrates a computation of a single time-frequency bin in a target phase correlation spectrogram 408 for the TPD 404 and a corresponding IPD 406, according to some embodiments. It may be noted that both the IPD 406 and TPD 404 may be modelled as complex numbers. Further, the target phase correlation spectrogram 408 may indicate a directional feature. In particular, the target phase correlation spectrogram 408 may be indicative of an angle difference between the complex numbers of the IPD 406 and the TPD 404.

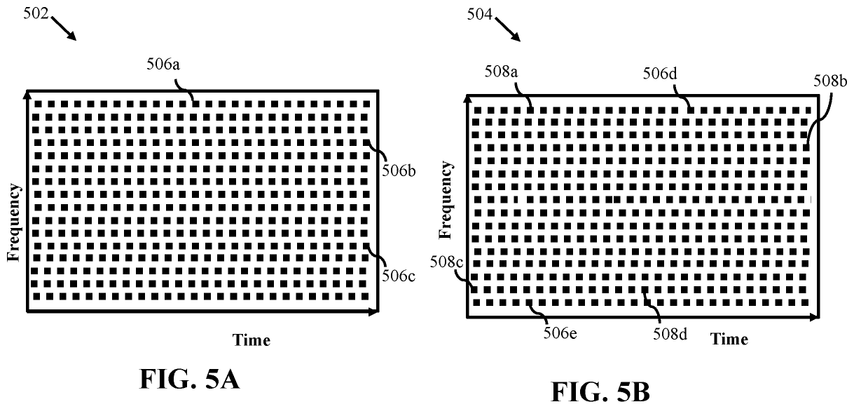

FIG. 5A and FIG. 5B show example illustrations of ideal target phase correlation spectrogram 502 and computed target phase correlation spectrogram 504, respectively, according to some embodiments. It may be noted that the values of the target phase correlation spectrograms 502 and 504 are complex numbers, but, for illustrative purpose and brevity, only real parts are shown in the FIG. 5A and FIG. 5B.

In an example, the target phase correlation spectrograms 502 and 504 may include a plurality of time-frequency bins (depicted as TF bins 506a, 506b, 506c, 506d, 506e, 508a, 508b, 508c, and 508d; collectively referred to as TF bins 506 and 508, hereinafter). For example, a TF bin from the TF bins 506 and 508 refers to a specific cell or element that represents a localized segment of time and frequency within the corresponding visualization of the spectrogram 502 or 504. For example, the target phase correlation spectrograms 502 and 504 may be a 2D representation of a signal's, such as the audio mixture 104 frequency content over time, where the x-axis represents time, the y-axis represents frequency. Moreover, the color or intensity of each of the TF bins 506 and 508 represents the magnitude of the signal's energy at that time and frequency.

In this regard, for example, the TF bins 506a, 506b, 506c, 506d, and 506e (depicted as black squares) in the computed target phase correlation spectrogram 502 and the ideal target phase correlation spectrogram 504 may indicate that the value of the target phase correlation spectrogram at those bins reaches a maximum value, which is based on a total number of microphones, p, present in the microphone array 102. In an example, the magnitude of the target phase correlation spectrogram computed from the audio mixture, measures how well the measured IPDs match the expected TPDs corresponding to the source location of the identified audio source, say the component 402a. When the IPD and TPD for a given TF bin is perfectly matched it will take the maximum value corresponding to the TF bins 506a, 506b, 506c, 506d, and 506e, depicted as black squares.

Referring to FIG. 5A, the ideal target phase correlation spectrogram 502 may correspond to, for example, an isolated signal from an audio source. In particular, each of the TF bins, such as the TF bins 506a, 506b and 506c in the ideal target phase correlation spectrogram 502 is represented to be at their maximum value, i.e., the corresponding IPDs are based on the total number of microphones, p. The maximum value is equal to the total number of microphones, p, as an IPD and a corresponding TPD may be computed for each of the p pairs of microphones, the maximum value of the target phase correlation spectrogram for a single pair of microphones is equal to one. Further, after summing over p pairs of microphones, the maximum value of the target phase correlation spectrogram over all p pairs of microphones may be equal to p.

Referring to FIG. 5B, the TF bins 508a, 508b, 508c, and 508d in the computed target phase correlation spectrogram 504 may indicate that corresponding IPDs are not well matched with the expected TPDs corresponding to the source location of the identified audio source. In an example, the TF bins 508a, 508b, 508c, and 508d, depicted as grey squares, may indicate that corresponding IPDs are less than p. In an example, the grey TF bins 508a, 508b, 508c, and 508d may indicate that the magnitude of the target phase correlation spectrogram computed from the audio mixture contains measured IPDs that are not well matched with the expected TPD corresponding to the source location of the identified audio source, say the component 402a, that is they are less than the maximum value at points in time and frequency corresponding to the TF bins 508a, 508b, 508c, and 508d. In particular, only some TF bins, depicted as TF bins 506c and 506d in black squares, are at maximum value for a target phase correlation spectrogram, while other TF bins depicted as TF bins 508a, 508b, 508c and 508d as grey squares are not at their maximum value as at corresponding time and frequency other audio source(s), corresponding to different TPD(s), may be dominant and, for example, noise and reverberation may also affect the magnitude.

Some embodiments of the present disclosure are based on a realization that the computed target phase correlation spectrogram 504 for the identified source or the component 402a should look as close as possible to the ideal target phase correlation spectrogram 502 to use the computed target phase correlation spectrogram 504 as a metric for measuring the quality of a source separation model when isolated signals corresponding to the identified audio source are unavailable.

In particular, TF bins 506d and 506e corresponding to black squares may be emphasized for extracting an audio signal of the identified audio source, say the component 402a, from the audio mixture, whereas TF bins 508a, 508b, 508c, and 508d, corresponding to grey squares may be de-emphasized. The computed target phase correlation spectrogram 504 may be provided as input to the neural network 202 separating audio sources at corresponding known locations and extracting audio signal that may be generated by the audio sources.

FIG. 6A illustrates an example flowchart for training the neural network 202 for extracting audio signals corresponding to audio sources, according to some embodiments. In an example, the neural network 202 is trained using a training dataset that is based on target phase correlation spectrograms. For example, training the neural network 202 using the target phase correlation spectrograms for subsequent audio signals separation is advantageous as the target phase correlation spectrograms provide useful runtime feature as network input since it provides a powerful cue for separating audio sources at known locations.

At 602, a training audio mixture of signals may be received. For example, such training audio mixture may be generated by one or more training audio sources. The training audio sources may include one or more tools performing one or more tasks and/or one or more actuators operating the one or more tools. For example, such training audio sources may be a part of a machine. A manner in which the training audio mixture may be collected from a training audio source is described in conjunction with, for example, FIG. 6B.

In an example, a training audio mixture may be an acoustic mixture comprising a combination of multiple sound sources or audio signals from multiple sound sources in a corresponding acoustic environment. For example, each acoustic signal in the training audio mixture may have its own unique characteristics and spatial locations. Pursuant to the present example, the one or more training audio sources forming the training audio mixture may be identified by location data relative to a location and an orientation of a microphone array, such as the microphone array 102, measuring the training audio mixture.

To this end, separating or isolating individual sound sources or audio signals from the training audio mixture is a challenging task, especially in situations where isolated sound signal of the one or more training audio sources is unavailable. For example, separated or isolated audio signals of corresponding audio sources within the audio mixture may be used for, for example, noise reduction, anomaly detection, maintenance of the audio sources, and more.

At 604, one or more training target phase correlation spectrograms associated with corresponding training audio sources are generated. For example, the one or more training target phase correlation spectrograms may be generated based on a correlation between spectral features of the training audio mixture and directional features indicative of the location data of the one or more training audio sources forming the training audio mixture.

In an example, the spectral features of the training audio mixture may include inter-channel phase differences of the training audio mixture. For example, the inter-channel phase differences of the training audio mixture may indicate phase differences, for example, delay, in the measured training audio mixture across the different channels, i.e., microphones, of the microphone array 102. Moreover, the directional features of the training audio mixture may include a target or an expected phase difference for a given audio source for which an audio signal is to be extracted. For example, the target phase difference for the given audio source may indicate a target or expected phase difference between when a sound from the given audio source should reach a reference channel of the microphone array 102 and when the sound should reach a non-reference channel of the microphone array 102. It may be noted that the target phase difference for the given audio source from the one or more training audio sources may be computed based on sound propagation properties. To this end, the target phase difference for the given audio source may be indicative of properties of sound propagation for, for example, known location data of the given audio source relative to known location of each microphone of the microphone array 102. In an example, target phase differences may be computed for each of the one or more training audio sources forming the audio mixture and for which the audio signal is to be extracted or separated.

Further, the inter-channel phase differences of the training audio mixture may be correlated with the target phase difference of the given audio source to compute a target phase correlation spectrogram for the given audio source. For example, based on the correlation of the inter-channel phase differences of the audio mixture with different target phase differences of the one or more audio sources, corresponding one or more training target phase correlation spectrograms may be computed.

To this end, each time-frequency (TF) bin of the training target phase correlation spectrogram defines a feature that quantifies a match between inter-channel phase differences observed in the spectrogram of the measured training audio mixture at a particular time and frequency and corresponding expected phase difference for the given audio source at the particular time and frequency. It may be noted that the TF bins of the one or more training target phase correlation spectrograms may be indicative of how well the phase differences observed in the measured spectrograms of the inter-channel phase differences match or align with respect to the corresponding expected or target phase differences for each of the one or more training audio sources.

At 606, the neural network may be trained to extract a training audio signal corresponding to the given audio source from the one or more training audio sources forming the training audio mixture based on the respective one or more training target phase correlation spectrograms. For example, when the measured inter-channel phase differences are correlated with the target phase difference for a given source location for the given audio source, i.e., in the target phase correlation spectrogram for the given audio source, TF bins with inter-channel phase differences well matched to the target phase difference are emphasized and TF bins not well matched will be de-emphasized for training the neural network 202. In an example, if the magnitude of correlation between the inter-channel phase differences and the target phase difference in the TF bin is high, the neural network can leverage this information to emphasize the features for this TF bin during the training. Additionally, or alternatively, the neural network is trained to utilize the magnitude of correlation for training and execution.

Pursuant to embodiments of the present disclosure, the one or more training target phase correlation spectrograms may be used as a training target when isolated source signals cannot be collected for training the deep neural network 202. In particular, for an isolated audio source at a known location, such as the given audio source at the given source location, an ideal target phase correlation spectrogram may be computed using physical properties of sound propagation and the measured inter-channel phase differences.

Further, in some embodiments, a difference between the computed one or more training target phase correlation spectrograms and an ideal value of target phase correlation spectrograms may be used to generate a set of loss function to train the neural network. Details of such training of the neural network 202 based on the set of loss functions are described in conjunction with, for example, FIGS. 6C and 6D.

FIG. 6B shows an example illustration of gathering the training audio mixture, according to some embodiments. In this regard, a scenario where a machine 608 with two sound generating training audio sources (depicted as training audio sources 608a and 608b) is present in an acoustic environment is considered.

Further, for collecting the training audio mixture, the microphone array 102 may be positioned arbitrarily, but with some constraints. For example, the microphone array 102 may be positioned at arbitrary locations, depicted as measurement locations q₀, q₁, and q₂. Such measurement locations q₀, q₁, and q₂ represent situations where it might not always be possible to place the microphone array 102 in the ideal position, such as close to the machine 608 or between the two training audio sources 608a and 608b, for example, due to obstacles in the acoustic environment. This ensures that the training audio mixture is similar to what would be measured in realistic conditions.

In an example, the microphone array 102 may include 11 microphones. For example, the microphones of the microphone array may be harmonically spaced. A spacing (in cm) between the microphones of the microphone array 102 may be, for example, 16.8, 8.4, 4.2, 2.1, 2.1, 2.1, 2.1, 4.2, 8.4, 16.8. To this end, for a total span or length of the microphone array 102 may be, for example, 67.2-68 cm. It may be noted that such dimensions and harmonic spacing between microphones is only exemplary and should not be construed as a limitation. In other embodiments, the harmonic spacing may have different values, or the microphones may be spaced apart uniformly, or their placement may not be linear.

Further, to collect the training audio mixture, the microphone array 102 may be positioned at the measurement locations q₀, q₁, and q₂. At the measurement location q₀, q₁, and q₂, the audio mixture generated by the training audio sources 608a and 608b may be measured.

Moreover, at the measurement location q₀, a relative location between the training audio source 608a and a reference microphone 102d of the microphone array 102 may be determined as L₀, q₀; and a relative location between the training audio source 608b and the reference microphone 102d of the microphone array 102 may be determined as L₁, q₀. Further, at the measurement location q₁, a relative location between the training audio source 608a and the reference microphone 102d may be determined as L₀, q₁; and a relative location between the training audio source 608b and the reference microphone 102d may be determined as L₁, q₁. Similarly, at the measurement location q₂, a relative location between the training audio source 608a and the reference microphone 102d may be determined as L₀, q₂; and a relative location between the training audio source 608b and the reference microphone 102d may be determined as L₁, 92. It may be noted that the reference microphone 102d may be arbitrarily chosen or pre-defined, for example, by a user. In an example, the reference microphone 102d may be a microphone that may lie at a center of the microphone array 102. Furthermore, when the array geometry and array orientation of the microphone array 102 are known, relative locations between the training audio source 608b and other non-reference microphones (such as microphones 102a and 102b) in the microphone array 102 can be determined based on the relative location between the training audio source 608b and the reference microphone 102d. To this end, such relative locations may be indicative of a distance and direction information between the microphones of the microphone array 102 and the training audio sources 608a and 608b at a corresponding measurement location.

For example, such relative locations (such as relative locations between the training audio source 608b and the reference microphone 102d at different measurement locations as well as relative locations between the training audio source 608b and the non-reference microphones at different measurement locations) may be used to create the training dataset for identifying relative location of the training audio sources 608a and 608b from the microphone array 102 and separating the training audio signals of the training audio sources 608a and 608b based on spatial information. To this end, the training audio mixture generated by the training audio sources 608a and 608b may be collected or measured by moving the microphone array 102 in different locations in proximity to the machine 608.

Once the training audio mixture is measured from different measurement locations, such as the measurement locations q₀, q₁, and q₂, in a real acoustic environment or a virtual acoustic environment, the training audio mixture may be used for training of the neural network 202. For example, target phase correlation spectrograms corresponding to the audio sources 608a and 608b may be processed by the neural network 202 for learning to extract training audio signals of the training audio sources 608a and 608b.

FIG. 6C show an example illustration of training the neural network 202 based on a set of loss functions, according to some embodiments. It may be noted that the microphone array 102 may measure the training audio mixture 610. The training audio mixture 610 may be a summation of audio signals produced by the training audio sources 608a and 608b of the machine 608. The training audio mixture 610, i.e., the spectral features of the training audio mixture 610 including a subset of complex short-time Fourier transform spectrograms, inter-channel phase difference spectrograms, and target phase correlation spectrograms for the known locations of the training audio sources 608a and 608b, may be processed with the neural network 202 to extract isolated training audio signals of the training audio sources 608a and 608b.

In an example, the training audio mixture is assumed to be a P-channel audio mixture signal, where γ∈ [symbol] ^{P×N} with length of N samples, which is a sum of reverberant isolated source signals from the training audio source, so, 608a and audio source, $1, 608b, i.e., γ=s₀+s₁. The neural network 202 may take as input time-frequency (T-F) mixtures Y=STFT(γ)∈ [symbol] ^{P×T×F}. The neural network 202 is configured to estimate Ŝᵢ∈ [symbol] ^{P×T×F} for i=0, 1, i.e., corresponding to the training audio sources 608a and 608b.

In an example, the neural network 202 may have a complex U-Net architecture. It may be noted that the U-Net architecture of the neural network 202 may include an encoder (not shown in FIG. 6C) and a decoder (not shown in FIG. 6C), with skip connections that connect corresponding layers between the encoder and decoder. In particular, the encoder may include alternating complex convolution layers and complex dense blocks, where each dense block of the encoder may have a skip connection to a corresponding block in the decoder and each dense block may have a batch normalization. In an example, the encoder part of the U-Net resembles a convolution neural network (CNN) architecture, such as including multiple convolutional and pooling layers that progressively reduce spatial dimensions of the input training target phase correlation spectrograms for identified spatial locations of each of the training audio sources 608a and 608b, while extracting high-level features of the training input features consisting of a subset of complex short-time Fourier transform spectrograms, inter-channel phase difference spectrograms, and target phase correlation spectrograms.

Moreover, for example, the decoder may be a multi-headed architecture that may be configured to up-sample and expand feature maps from the encoder back to the number of time frequency bins present in the input training audio mixture spectrogram. For example, the decoder may include a series of up-sampling layers, such as those using transposed convolutions or interpolation, followed by convolutional layers to generate a dense prediction map of extracted training audio signals of the identified training audio sources 608a and 608b that matches the shape of the input training audio mixture spectrogram. Moreover, the skip connections may directly connect corresponding layers between the encoder and the decoder that may help retain detailed spatial information from the encoder and improve the accuracy of segmentation of the training audio signals from the audio mixture.

Further, during training, the neural network 202 may be trained on, for example, chunks of STFT frames from the audio mixture signal, the training target phase correlation spectrogram, and/or other input features corresponding to a particular time frame. Once the neural network is trained on the train subset or the training audio mixture, results of the training may be generated. The results of the training may include separated training audio signals 612a and 612b corresponding to the training audio sources 608a and 608b, respectively.

If isolated source signals are available, then complex T-F representations of the true source signals Sᵢ may be used as training targets. However, for the machine 608, isolated source signals from the training audio sources 608a and 608b are unavailable. When isolated sources or isolated signals are not available for training, an objective of some embodiments of the present disclosure is to ensure that the separated sources, i.e., the training audio signals 612a and 612b, output by the neural network 202 can reconstruct the training audio mixture 610. In this regard, validation of the training audio signals 612a and 612b to reconstruct the training audio mixture 610 may be performed based on the set of loss functions.

In an example, the set of loss functions may include location loss functions 614a and 614b corresponding to how well the target phase correlation spectrograms of the separated audio signal estimates 612a and 612b match the known locations of audio sources 608a and 608b, respectively. For example, to ensure separation of the training audio mixture 610, a loss based on the target phase correlation spectrograms, i.e., the location loss functions 614a and 614b, are used. Pursuant to present example, the location loss is computed using the separated source estimates, Ŝᵢ, i.e., the training audio signal estimates 612a and 612b. In an example, the location loss functions 614a and 614b may be defined as:

$${ℒ}_{loc} = {\sum }_{i = 1}^{2} {\sum }_{f} {\sum }_{t} ( {\vert \vert ( {d}_{t , f} ( {\hat{S}}_{i} , {L}_{i} ) ) - P \vert \vert}_{2}^{2} - {\vert \vert 𝒥 ( {d}_{t , f} ( {\hat{S}}_{i} , {L}_{i} ) ) - 0 \vert \vert}_{2}^{2} ) \qquad ( 1 )$$

Where d_{t,f}(Ŝᵢ, Lᵢ)=Σₚ₌₁^{P-1}TDP_{f}^{p}(Lᵢ)I̅P̅D̅_{t,f}^{p}(Ŝᵢ)∈ [symbol] is the target phase correlation spectrogram computed using the i^{th} estimated separated training audio signal 612a or 612b and true location Lᵢ (i.e., L₀ and L₁) of the corresponding training audio source 608a or 608b. In an example, the location losses 614a and 614b for the separated training audio signals 612a or 612b ensures that the separated training audio signals 612a or 612b match the true locations, where d_{t,f}(Ŝᵢ, Lᵢ)=P+0j when the inter-channel phase differences of the separated training audio signals 612a or 612b match the target or expected phase delays of the known source locations for the training audio sources 608a and 608b. For example, an output order of the estimated separated training audio signals 612a or 612b may be unambiguously determined by order of source locations input to the neural network 202. For example, the location loss functions 614a and 614b are determined for each TF bin of the separated training audio signals 612a and 612b corresponding to the training audio sources 608a and 608b.

Referring to FIG. 6D, an example flow diagram illustrating computation of the location loss functions 614a and 614b (collectively referred to as location loss function 614) is shown for training the neural network 202, according to some embodiments. It may be noted that the multi-channel separated source spectrogram 618 includes the estimated separated training audio signals 612a and 612b. Moreover, the source and microphone positions 620 may indicate known locations, i.e., L₀ and L₁, of the training audio sources 608a and 608b, respectively, as well as known location of the microphones of the microphone array 102. For example, using sound propagation properties and the known location of the training audio sources 608a and 608b and the microphones, target phase differences 622 may be computed.

Further, for example, the target phase differences 622 may be compared or correlated with inter-channel phase differences 624 of the separated training audio signals 612a and 612b to obtain directional features or target phase correlation spectrograms 626 for the separated training audio signals 612a and 612b.

In one example, an ideal training target phase correlation spectrogram may be computed using physical properties of sound propagation for the training audio sources 608a and 608b. The distances and location of the training audio sources 608a and 608b is known. Further, a difference between the target phase correlation spectrogram computed using the separated audio signals 612a and 612b and the corresponding ideal target phase correlation spectrogram for each of the training audio sources 608a and 608b may be determined. For example, differences in the target phase correlation spectrograms may indicate the location loss functions 614a and 614b.

In an example, the computed target phase correlation spectrograms for the location losses may be P+0j when the inter-channel phase differences 624 of the separated training audio signals 612a and 612b match the expected phase delays or the target phase differences 622 of the known source locations of the training audio sources 608a and 608b. Subsequently, the location losses 614a and 614b (collectively referred to as location loss 614) may be computed based on square error 628 terms and differences in the target phase correlation spectrogram from ideal target phase correlation spectrogram.

Returning to FIG. 6C, the set of loss functions may include a reconstruction loss function 616. In an example, the reconstruction loss function 616 may include two components, namely, spectral loss and time domain spatial covariance loss. For example, the spectral loss for input audio mixture complex spectrogram Y and associated estimate Ŷ may be defined as:

$${ℒ}_{s p e c} = {‖ Y - \hat{Y} ‖}_{2}^{2} + {‖ \vert \hat{Y} \vert - \vert Y \vert ‖}_{2}^{2} \qquad ( 2 )$$

Moreover, the time domain spatial covariance loss may be defined as:

$${ℒ}_{s p a t} = {‖ {yy}^{T} - \hat{y} {\hat{y}}^{T} ‖}_{2}^{2} \qquad ( 3 )$$

Continuing further, \hat{γ}=iSTFT(Ŝ₀)+iSTFT(Ŝ₁) may be estimated mixture from the reconstruction of the separated training audio signals 612a and 612b. To this end, the reconstruction loss function only ensures that a sum of combined outputs, i.e., the training audio signals 612a and 612b, of the neural network 202 is approximately equal to the input training audio mixture 610. In an example, the reconstruction loss function [symbol] ₛₚₐₜ may be used to validate if the training audio mixture 610 is fully reconstructed from the training audio signals 612a and 612b and there is no loss of audio content. For example, the reconstruction loss function 616 is associated with a summation of the extracted training audio signals 612a and 612b for reconstructing the training audio mixture 610.

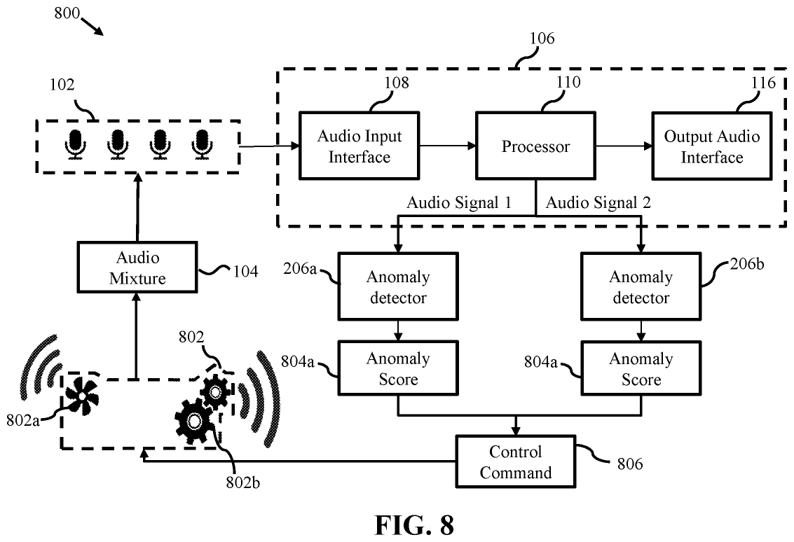

Further total losses or a loss function may be defined as:

$$ℒ = {β}_{s p e c} {ℒ}_{s p e c} + {β}_{s p a t} {ℒ}_{s p a t} + {β}_{loc} {ℒ}_{loc} \qquad ( 4 )$$

where β_{spec}, βₛₚₐₜ and β_{loc} are hyperparameters that weigh each term of the loss functions. For example, based on the loss function, [symbol] , the learning of the neural network 202 may be validated. In some cases, the neural network 202 may be re-trained based on the same training dataset or different training dataset. In this manner, the neural network 202 may be trained for extracting or separating audio signals from an audio mixture. Once trained, the neural network 202 may be deployed, for example, in an industry, or an environment having complex machines, for separating audio signals of different audio sources operating coherently. Details of operation of the neural network 202 in different acoustic environments are described in conjunction with, for example, FIG. 7A, FIG. 7B, and FIG. 7C and FIG. 8.

FIG. 7A shows a network architecture of the neural network 202, according to some embodiments. In this regard, a multi-channel audio mixture 702 (such as the audio mixture 104) may be provided as input to the neural network 202. Moreover, known relative locations of microphones of the microphone array 102 and known relative locations of audio sources, such as the actuators 302 and/or tool 304 of the machine 234 that may be forming the audio mixture 702 may be provided as input to the neural network 202. Such known locations are depicted as source and microphone positions 704.

In one embodiment, a pre-processing step of feature extraction 706 may be performed on the multi-channel audio mixture 702 and the source and microphone positions 704. Such extracted feature at 706 may be provided as input to the neural network 202. Details of feature extraction are described in conjunction with, for example, FIG. 7B.

Some embodiments are based on a recognition that a target phase correlation spectrogram indicative of comparison of spectral features or inter-channel phase differences of the measured multi-channel audio mixture 702 and target phase differences based on source locations for identified audio sources forming the multi-channel audio mixture 702 may be useful for training the neural network 202. In an example, the neural network 202 may have a complex U-Net architecture.

In an example, the U-Net architecture may include a complex convolution encoder 708 (referred to as encoder 708, hereinafter), a complex bidirectional Long Short-Term Memory (BLSTM) module 710, and complex convolution decoder 1 712a and complex convolution decoder 2 712b (collectively referred to as decoders 712, hereinafter). Although the present example describes two complex convolution decoders 712a and 712b, this should not be construed as a limitation. In other examples, the U-Net architecture may include a scalable number of decoders, for example, based on a number of known audio source locations forming the audio mixture to be separated.

For example, the encoder 708 may include alternating complex convolution layers and complex dense blocks, where each dense block of the encoder 708 may have a skip connection to a corresponding block in the decoders 712 and each dense block may have a batch normalization. During operation, the encoder 708 may be configured to reduce spatial dimensions of the input features, which may include multi-channel STFT, IPDs, frequency positional encodings, and the target phase correlation spectrogram for identified spatial locations of the identified audio source forming the audio mixture 702 to identify and extract separated or isolated audio signal of the audio sources. Further, the complex BLSTM 710 operates between the encoder 708 and the decoders 712. In an example, the BLSTM may be arranged to process outputs of the complex convolutional encoder 708.

Further, for example, all convolution layers of the encoder 708 may use a stride of one in a time dimension and a stride of two in a frequency dimension such that an output of the encoder 708 or an input of the BLSTM 710 transforms the input features from a shape of C×T×F, that becomes 256×T×1 at the input of the BLSTM 710. Moreover, a number of frequency bins may be F=257, and a number of channels C may depend on a number of microphones and input features, e.g., 11 microphones, 10 IPDs, 2 target phase correlation spectrograms, and 10 frequency positional encoding channels that sums to C=33. It may be noted that only a subset of the input features are required, i.e., the frequency positional encodings or target phase correlation spectrograms may not be included as input to the network.

In an example, each dense block of the encoder 708 may contain a skip connection and batch normalization. Further, the decoders 712 may be multi-head decoders as the neural network 202 outputs separated audio signals for two audio sources instead of a single source from the audio mixture 702. For example, the decoders 712 may be arranged to process the outputs of the complex convolutional encoder 708 and outputs of the complex BLSTM module 710. In an example, the neural network 202 may output the separated audio signals as multi-channel complex spectrograms. To this end, the neural network 202 may be configured to extract audio signals of multiple identified audio sources forming the audio mixture 702. For example, the complex U-net architecture includes at least one complex convolutional decoder for each of the identified audio sources, such as two decoders for reconstructing separated audio signals of two respective audio sources.

It may be noted that a main advantage of the U-Net architecture of the neural network 202 for processing target phase correlation spectrograms is the ability to learn features in both local and global natures at multiple scales, while still having an output that is a same shape as the input, such as the multi-channel complex spectrogram of the observed audio mixture signal. Each layer in the convolutional encoder 708 progressively learns a feature representation that is global in nature. Then the convolutional decoders 712 reconstruct a corresponding separated audio signal of an audio source starting from a global representation at the encoder 708 output, and each decoder layer progressively learns a more local feature representation. Moreover, the skip connections are crucial between each corresponding encoder 708 and decoder 712 at a common scale, such that information from the encoder 708 can be re-injected into the decoders 712 for both local and global details that should be present in the processed spectrogram (i.e., U-Net output) of the separated audio signals for the identified audio sources. These properties make the U-Net architecture a strong deep network architecture for audio source separation.

Based on the training of the U-net architecture and the multi-channel complex spectrogram of the observed audio mixture signal as input, the neural network 202 may be configured to output an estimated multi-channel complex spectrogram part 1 and estimated multi-channel complex spectrogram part 2. For example, the estimated multi-channel complex spectrogram part 1 may be spectrogram or separated audio signal corresponding to an audio source 1; and the estimated multi-channel complex spectrogram part 2 may be spectrogram or separated audio signal corresponding to an audio source 2. It may be noted that separation of the multi-channel audio mixture 702 into the estimated multi-channel complex spectrogram part 1 and the estimated multi-channel complex spectrogram part 2 is only exemplary.

Referring to FIG. 7B, there is shown a flow diagram illustrating computation of input features for the neural network 202, according to some embodiments. The computation of the input features corresponds to the feature extraction 706 step of the FIG. 7A.

In this regard, the multi-channel audio mixture 702 measured by the microphone array 102 and the known source and microphone positions 704 may be used for the feature extraction 706. In an example, the multi-channel audio mixture 702 may be processed to compute multi-channel short time Fourier transform (STFT) 722. For example, the measured multi-channel audio mixture 702 may be transformed to produce the multi-channel STFT 722 of the received audio mixture 702. In particular, Fourier Transform may be applied to small, overlapping sections of the audio mixture 702 signal, for example, using a windowing function. The produced multi-channel STFT 722 may be used to extract local frequency information of the audio mixture 702. Based on the frequency information of the measured audio mixture 702, for example, 2D representation or spectrogram may be generated showing change in frequency over time. Therefore, the multi-channel STFT 722 corresponds to representation of the audio mixture 702 as a signal for processing by the neural network 202.

Further, from the complex spectrogram of the measured audio mixture 702, inter-channel phase differences (IPDs) 718 may be computed. Such IPDs 718 may arise due to phase differences in different channels or microphones of the microphone array 102 measuring the audio mixture 702. To this end, the IPDs 718 between different channels in the multi-channel STFT are determined. In an example, the IPDs 718 may represent relative phase differences between each non-reference channel in the microphone array 102 and the reference channel in the microphone array 102. Details of the IPDs are described in conjunction with, for example, FIG. 7C. While the computation of the IPDs and the target phase correlation spectrogram is here only illustrated for the measured audio mixture 702, the same mechanisms may be used to compute IPDs and estimated training target phase correlation spectrograms for the estimated separated training audio signals 612a and 612b. For example, the IPDs and the estimated training target phase correlation spectrograms for the estimated separated training audio signals 612a and 612b may be used to determine losses, such as location losses, that may be used to re-train the neural network and/or updated weights of the neural network.

Thereafter, using directional information indicating locations or positions of audio source and the microphone array 102, target phase differences (TPDs) of a sound propagating from a relative location of the identified audio source to different microphones in the microphone array may be determined. In an example, the TPDs may be determined using reference microphone and non-reference microphones in the microphone array 102. Details of the TPDs are described in conjunction with, for example, FIG. 7C.

In an example, frequency position encodings 724 are determined to ensure that the neural network 202 is able to do frequency dependent processing in the early convolutional layers of the U-Net. To generate the frequency position encodings 724, frequency bin index of the measured spectrogram of the audio mixture 702 may be represented as, for example, a 10-dimensional vector using sinusoidal functions of the bin index. In this way, relative positioning information of the audio sources may be embedded in the frequency information of the measured spectrogram. In particular, the frequency position encodings 724 adds an additional layer of control and manipulation over the spectral properties of the audio mixture 702, enabling more effective audio processing for audio signal separation. Techniques used for generating the frequency position encodings 724 may include, but is not limited to, logarithmic scaling, perceptual weighting, or psychoacoustic modeling.

Continuing further, the IPDs 718 are correlated with the TPDs 716 to produce a target phase correlation spectrogram 720. For example, values of the target phase correlation spectrogram for different time-frequency (TF) bins quantify alignment of the IPDs in a time-frequency bin with the TPDs of the same time-frequency bin which are the expected phase difference for that time-frequency bin. For example, the target phase correlation spectrogram 720 encodes information about where an identified audio source for which audio signal is to be separated is located. Details of the target phase correlation spectrogram are described in conjunction with FIGS. 3, 4A, 4B, 5A, and 5B.

In an example, the target phase correlation spectrogram 720 may be combined with the multi-channel STFT 722 and the frequency position encodings 724 to produce a channel concatenation 726 of the received audio mixture 702. In one example, the channel concatenation 726 of multiple sets of features is used as input to the neural network 202. For example, each set of features specializes in encoding different information, such as array shape is encoded in the IPDs 718, target location of the identified audio source is encoded in the target phase correlation spectrogram 720, audio mixture signal is encoded in the multi-channel STFT 722, and frequency dependent processing is ensured by the frequency positional encodings 724. In an example, the channel concatenation 726 combines the multiple sets of features by stacking the features along a new dimension that may be referred to as channel dimensions. It may be noted that in practice the channel concatenation block 726 may take only a subset including one or more of the multiple sets of features, if some features are unavailable due to limited computation, data availability, or other constraints.

Once the channel concatenation 726 of the multiple sets of features is generated, the channel concatenation 726 of the received audio mixture 702 may be processed with the neural network 202 to extract the audio signal of the identified audio source. A manner in which the neural network 202 separates the audio signal for the identified audio source is described in conjunction with FIG. 7A.

FIG. 7C shows a flow diagram illustrating computation of the target phase correlation spectrogram 720 which can be used as an input feature and to compute a loss function for extracting the audio signal, according to some embodiments. In an example, the target phase correlation spectrogram 720 may include complex numbers, i.e., having real and imaginary or complex values. For example, the complex numbers of the target phase correlation spectrogram 720 may correspond to values of TF bins in the target phase correlation spectrogram 720. Moreover, the neural network 202 having the U-Net architecture is a complex neural network for processing the complex numbers of the target phase correlation spectrogram 720.

It may be understood that the target phase correlation spectrogram 720 is computed based on the IPDs 718 and the TPDs 716. In an example, the values of phase differences in the IPDs 718 and the TPDs 716 may be complex numbers.

Pursuant to present example, the audio mixture 702 is considered to be a P-channel audio mixture signal, where γ∈ [symbol] ^{P×N} with length of N samples. Based on Fourier transform of the audio mixture, input time-frequency (T-F) mixtures Y=STFT(γ)∈ [symbol] ^{P×T×F} may be generated. In addition to using the complex multi-channel spectrogram Y as input to the neural network 202, other input features are also considered. In multi-channel scenarios, interaural or inter-channel phase difference (IPD) may be used to indicate spatial features. For example, an IPD may be defined as:

$$Real ‐ {IPD}_{t , f}^{p} ( Y ) = ∠ {Y}_{t , f}^{{p}_{0}} - ∠ {Y}_{t , f}^{p} ∈ ℝ \qquad ( 5 )$$

where p₀ is the reference microphone 102d, and the IPD is computed for each of the non-reference microphones, i.e., p=1, . . . , P−1. To mitigate discontinuities caused by phase wrapping, IPD features are typically mapped to a complex number, defined as:

$${IPD}_{t , f}^{p} ( Y ) = cos ( Real ‐ {IPD}_{t , f}^{p} ( Y ) ) + jsin ( Real ‐ {IPD}_{t , f}^{p} ( Y ) ) ∈ ℂ \qquad ( 6 )$$

For example, to determine the IPDs 718, the Fourier transform of the measured values of the audio mixture across the multiple channels of the microphone array 102 may be used. In this regard, the STFT of each channel in the microphone array 102 may be computed by taking Fourier transform of small, windowed segments of the audio mixture measured. In an example, a time period for the windowed segments may be in a range of 20 milliseconds (ms) to 50 ms. The STFT output (i.e., complex spectrograms) may be represented as a complex number in magnitude phase format.

Thereafter, a difference in phase angles between each non-reference microphone and the reference microphone may be computed. For example, difference in phase angle between different non-reference channels (such as non-reference microphone STFT 732) and phase angle of STFT of the reference channel at the reference microphone 102d, (i.e., reference microphone STFT 730) in the multi-channel STFT may be computed. Based on the comparison of non-reference microphone STFTs of different microphones, inter-channel phase angle differences (IPDs) may be produced for various non-reference channels, such as non-reference microphone 102b with respect to the reference microphone 102d or the reference channel in the microphone array 102. For example, the reference microphone 102d may be a microphone located at a center of the microphone array 102. In this manner, each channel or microphone may be analyzed independently to examine frequency content of each channel over time, and further identify phase difference in each non-reference channel STFT 730 over the reference channel STFT 732.

In an example, to avoid phase wrapping discontinuities, the phase angle differences or the IPDs 718 may be converted into complex numbers. As may be understood, each of the complex numbers may have a real part and an imaginary part. Pursuant to IPDs 718, the real part of the complex numbers may be indicative of a cosine 734 of a corresponding phase angle difference, whereas the imaginary parts of the complex numbers are indicative of a sine 736 of the corresponding phase angle difference. The real part, i.e., the cosines 734, and the imaginary part, i.e., the sines 736 of the represented complex IPDs may be used to produce complex conjugates 738 for the phase angle differences of the represented complex IPDs 718 by summing the real and imaginary components and changing the sign of the imaginary component of the complex number.

Similarly, to determine the TPDs 716, the known location information or positions of the identified audio sources and the microphones of the microphone array 102 may be used to compute time delay. In this regard, first, distances between the identified or known source locations 744 of the audio sources and position value 740 of the reference microphone 102d may be computed. Further, the distances may be divided by the speed of sound c to obtain a time of arrival at the reference microphone. The same procedure may then be repeated using position values 742 of the non-reference microphones and relative source locations 744 of the audio sources. In an example, the time of arrival at the reference microphone is subtracted from the time of arrival at the non-reference microphones to obtain time differences of arrival at the non-reference microphones.

For example, when a source location Lᵢ=[xᵢ, yᵢ, zᵢ] of an identified audio source defined relative to the reference microphone 102d, p₀, is known, pure time delay may be defined as: τ(Lᵢ, p) in seconds between an audio signal or sound propagating from a source location located at Lᵢ traveling to a non-refence microphone p and the signal traveling to the reference microphone p₀. In an example, a target phase difference (TPD) for source i is defined as:

$${TPD}_{f}^{p} ( {L}_{i} ) = cos ( 2 π f τ ( {L}_{i} , p ) ) + j sin ( 2 π f τ ( {L}_{i} , p ) ) ∈ ℂ \qquad ( 7 )$$

The time differences of arrival may then be converted to the TPDs for each time-frequency bin of the spectrogram using equation (7). It may be noted, a TPD may be computed based on a time delay between when a sound, such as the audio mixture 702 propagating from a source location of an identified audio source arrives at a reference channel or the reference microphone 102d and when it arrives at a non-reference channel or the non-reference microphone 102b. For example, based on the time delay in the propagation of sound from the source locations 744 of the identified audio sources to the reference microphone 102d and the non-reference microphone 102b, and position values of the machine and the microphones of the microphone array 102, the TPDs 716 may be computed.

Further, the TPDs 716 are also represented as complex numbers. For example, each of the complex numbers of the TPDs 716 may have a real part and an imaginary part. Pursuant to TPDs 716, the real part of the complex numbers may be indicative of a cosine 746 of a corresponding target phase angle difference, whereas the imaginary parts of the complex numbers are indicative of a sine 748 of the corresponding target phase angle difference. The real part, i.e., the cosines 746, and the imaginary part, i.e., the sines 748 of the represented complex TPDs 716 may be used to produce complex numbers 750 by summing the real and imaginary components for the target phase angle differences of the represented complex TPDs 716.

Further, products for each of the complex conjugates 738 of the IPDs 718 with complex numbers 750 of the TPDs for each of the time-frequency bins may be determined. For example, a complex conjugate of an IPD and complex numbers of a TPD corresponding to same TF bin may be multiplied. In this manner, complex coordinates 738 of each of the IPDs 718 may be multiplied with corresponding complex numbers 750 of the TPDs. Such products may then be summed or aggregated over all non-reference channels to generate the target phase correlation spectrogram 720.

In an example, the target phase correlation serves as location conditioning in terms of an input feature, which indicates whether a T-F bin in spectrogram Y is dominated by an audio source at source location, Lᵢ, or not. The target phase correlation spectrogram 720 is defined as:

$${d}_{t , f} ( Y , {L}_{i} ) = {\sum }_{p = 1}^{P - 1} {TDP}_{f}^{p} ( {L}_{i} ) {\overline{IPD}}_{t , f}^{p} ( Y ) ∈ ℂ \qquad ( 8 )$$

where I̅P̅D̅_{t,f}^{p} is the complex conjugate of IPD_{t,f}^{p}. Further, neural network input may include the multi-channel complex spectrogram, IPDs, DF, and frequency positional encodings concatenated along the feature dimension. The target phase correlation spectrogram 720 may be processed using the neural network 202 to extract isolated audio signal for an identified audio source, such as the component 402a. Based on the isolated audio signal that may be generated by the identified audio source 402a, certain audio analysis may be performed. In an example, the formula (8) may also be applied to estimated separated training audio signals, such as the training audio signals 612a and 612b for computing loss for training. In this case, (Y) may be replaced with the spectrogram of the separated training audio signals 612a and 612b to compute the estimated training target phase correlation spectrograms of the separated training audio signals 612a and 612b. Further, the estimated training target phase correlation spectrograms of the separated training audio signals 612a and 612b may be used to compute loss during training.

The target phase correlation spectrogram 720 is computed for each time-frequency bin so it is fully synchronous with other input features such as the complex spectrograms and those features derived from the complex spectrogram such as IPDs. Further, any time-frequency bins with IPDs not well matched to the expected TPDs will be de-emphasized, and well-matched time-frequency bins will be emphasized to ensure accurate separation of the audio signals from the audio mixture 702.

According to an example embodiment of the present disclosure, the neural network 202 is configured to take as input the target phase correlation spectrogram 720. In one example, a neural network module of the neural network 202 may be configured to use the complex BLSTM module 710 between the convolution encoder 708 and the convolution decoders 712a and 712b. The complex BLSTM module 710 may output multi-channel complex target phase correlation spectrograms for the audio mixtures.

In an example, based on analysis of the extracted audio signal of the identified audio source, a control command for the operation of the machine the identified audio source of the machine, may be identified. Such control command may be associated with a current operating condition of the machine and/or the identified audio source, a required operating condition of the machine and/or the identified audio source, a health condition of the machine and/or the identified audio source, etc. for example, such control command may be transmitted to the machine over a wired or a wireless communication channel to cause the machine to perform certain tasks. For example, when the analysis of the extracted audio signal of the identified audio source indicates low fuel or raw material in a manufacturing machine, a control command for refilling a fuel tank or raw material container may be transmitted to the machine.

It may be noted that such analysis of the extracted audio signal of the identified audio source for identifying fuel levels is only exemplary. The extracted audio signal may be used for, for example, any kind of spatial audio analysis, surround sound processing, etc. An example implementation of analysis of the extracted audio signal is defined in conjunction with, for example, FIG. 8.

Referring to FIG. 8, there is shown a schematic diagram 800 illustrating controlling machining operations based on anomaly detection, according to some embodiments. The schematic diagram 800 includes a machine 802 comprising components 802a and 802b. For example, the components 802a and 802b of the machine 802 may produce audio signals during operation. For example, the component 802a may be a tool and the component 802b may be an actuator actuating the tool. To this end, the components 802a and 802b may operate coherently to perform a task, such as a machining task, an assembly task, a manufacturing task, etc.

In an example, the machine 802 may use sensors to collect data. The sensor can be digital sensors, analog sensors, and combination thereof. The collected data may serve two purposes, some of data are stored in training data pool and used as training data to the neural network 202 and some of data may be used as operation time data by an anomaly detection model to detect anomaly. The same piece of data can be used by both neural network 202 and the anomaly detection model.

To detect anomaly operation of the machine 802, specifically, in operation of any of the individual components 802a and/or 802b, the training data may be first collected. The training data for anomaly detection may be used to train the anomaly detection model. The training data may include either labeled data or unlabeled data. The labeled data may have been tagged with labels, e.g., anomalous, or normal. Unlabeled data have no label, but are typically assumed to be non-anomalous data collected during normal machine operation. Based on types of training data, the machine learning-based anomaly detection model applies different training approaches. For labeled training data, supervised learning is typically used and for unlabeled training data, unsupervised learning is typically applied. In such a manner, different embodiments can manage different types of data.

In an example, the machine learning-based anomaly detection model learns features and patterns of the training data, which include the normal data patterns and abnormal data patterns. The anomaly detection model uses the learnt parameters of the training and the collected operation time data, such as separated audio signals of the components 802a and/or 802b to perform anomaly detection. The operation time data, i.e., separated audio signals, can be identified as normal or abnormal. For example, using normal data patterns, the trained machine learning-based anomaly detection model can classify operation time data into normal data and abnormal data. Once an anomaly is detected, necessary actions are taken.

In operation, the components 802a and 802b may individually produce sound or audio signals. A summation of the audio signals may be measured as an audio mixture 104, by the microphone array 102. For example, the microphone array 102 may provide the audio mixture 104 to the audio system 106, specifically, the audio input interface 108 of the audio system 106. Further, the audio input interface 108 may receive the audio mixture 104 and provide it to the processor 110. For example, the processor 110 may be configured to generate spectral features consisting first of multi-channel STFT 722, which can be used to compute inter-channel phase angle differences in the multiple channels of the microphone array 102 in measuring the audio mixture 104. Moreover, the processor 110 may be configured to identify the audio sources, i.e., the components 802a and 802b based on known locations of the components 802a and 802b relative to a location of each of the microphones of the microphone array 102. For example, the processor 110 may be configured to identify the components 802a and 802b based on the relative locations using image sensors or schematic of an environment where the machine 802 is positioned. The processor 110 may represent directional information of the microphones and the audio sources 802a and 802b within target phase angle differences. The TPDs may encode spatial information corresponding to the microphones of the microphone array 102 and the audio sources 802a and 802b in order of time delay in sound propagation. Further, the processor 110 is configured to correlate spectral features, i.e., IPDs of the measures multi-channel spectrogram with target or expected phase angles to generate the target phase correlation spectrogram 720.

The target phase correlation spectrogram 720 may indicate directional features of the audio mixture 104. For example, the processor 110 may be configured to process the target phase correlation spectrogram 720 with the neural network 202 to extract audio signals, say an estimated multi-channel complex spectrogram part 1 corresponding to the component 802a and an estimated multi-channel complex spectrogram part 2 corresponding to the component 802b. The generated estimated multi-channel complex spectrogram part 1 and the estimated multi-channel complex spectrogram part 2, when added may result in the audio mixture. For example, the neural network 202 may extract several features of the audio mixture 104, the components 802a and 802b and source locations of the components 802a and 802b, such as array shape based on the IPDs, target locations of the components 802a and 802b based on the target phase correlation spectrogram 720, audio mixture signal based on multi-channel STFT of the audio mixture 104, and frequency related information based on frequency positional encodings.

Once the separated audio signals composing the audio mixture 104 are separated, they can be used to monitor a performance state of the individual components, or as a control signal to control the different components 802a and 802b independently. For example, the extracted audio signals may be provided to the anomaly detectors 206a and 206b (collectively referred to as anomaly detectors 206), respectively. For example, the audio signal 1 corresponding to the component 802a may be fed to the anomaly detector 206a, while the audio signal 2 corresponding to the component 802b may be fed to the anomaly detector 206b. The anomaly detectors 206a and 206b may include the machine learning-based anomaly detection models. The anomaly detection model of the anomaly detector 206a may be configured to identify if the isolated audio signal 1 satisfies normal behavior or normal operation of the component 802a. Similarly, the anomaly detection model of the anomaly detector 206b may be configured to identify if the isolated audio signal 2 satisfies normal behavior or normal operation of the component 802b.

In one example, the anomaly detectors 206 may be configured to determine an anomaly score for each of the identified acoustic sources 802a and 802b. For example, the isolated audio signal 1 fed to the anomaly detector 206a may determine an anomaly score 804a for the component 802a based on the isolated audio signal 1 corresponding to the component 802a. Similarly, the isolated audio signal 2 fed to the anomaly detector 206b may determine an anomaly score 804b for the component 802b based on the isolated audio signal 2 corresponding to the component 802b. In an example, the isolated audio signals 1 and 2 may be analyzed based on predictive patterns associated with possible anomalies of the components 802a and 802b to generate the anomaly scores 804a and 804b. For example, if the components 802a and 802b are operating normally, then the anomaly score may be low, such as less than 1. However, if the components 802a and 802b are operating abnormally, then the anomaly score may be high, such as greater than 7. For example, the anomaly score may be defined on a scale of 0-10, 0-1, in terms of an alphabetic character or grade, and so forth.

To this end, the anomaly score 804a and 804b may indicate a correlation between a type of an anomaly in the components 802a and 802b and a state of the identified acoustic source, i.e., the components 802a and 802b. For example, the processor 110 or the anomaly detectors 206 may be configured to compare the generated anomaly scores 804a and 804b with an anomaly threshold. In an example, the anomaly threshold may be pre-defined, such as by manufacturers of the components 802a and 802b, manufacturers of the machine 802, users operating the machine 802, etc. In certain other cases, the anomaly threshold may be dynamically determined.

In one example, by using the embodiments of the present disclosure for sound separation and anomaly detection, accuracy of anomaly detection may be increased. For example, using the neural network 202, the extracted audio signals, such as the audio signals 1 and 2 are accurately mapped to corresponding audio sources, such as the components 802a and 802b. This is especially advantageous in cases where a large number of components may be present in a machine. In these situations, if all components except one are operating normally, and we do not separate the sound signals, the sound of the anomalous component may be masked (i.e., undetectable) by the sound of the normally operating components, as the normally operating components may produce louder sound signals. However, by separating the sound signals of each component, anomalies in specific components may be detected. Further, using the extracted audio signals for anomaly detection is beneficial as when an anomaly is detected it will be associated with a specific component, which will minimize the effort required to repair the anomalous component, since it will already have been identified, and the necessary testing required to identify the anomalous component will have been eliminated. This ensures cost-effective repair, reduced downtime and increased reliability on operation of the machine.

Further, the processor 110 or the anomaly detectors 206 may be configured to select a control command 806 from a set of control commands to be performed by the machine 802 when any of the anomaly scores 804a and 804b is greater than the anomaly threshold. For example, the control command 806 may be instructions for the machine 802 to bring back operation of the machine 802 into normal operating range. Subsequently, the selected control command 806 may be transmitted to the machine 802 for overcoming an anomaly at any of the audio sources or components 802a and 802b. In this manner, a mode of operation of the machine 802 may be changed, such as by changing the operating condition of the components 802a and/or 802b. In certain cases, the control command may cause a shutdown of the machine 802 to prevent further anomalous or abnormal operation. This may be crucial in sudden faults in, for example, heavy electrical equipment, etc.

In one example, the control command 806 may be instructions for the machine 802 to give up control to a downstream controller. For example, such a downstream controller may be configured to execute operations to bring back the machine 802 to normal operating range to address anomalous behavior of the components 802a and/or 802b. In certain cases, the processor 110 or the anomaly detectors 206 may be configured to transfer the anomaly scores 804 to the downstream controller for, for example, handling fault, monitoring heat, monitoring operations, etc. for the machine 802 and its components 802a and 802b.

In another example, the extracted audio signals from the audio mixture 104 generated by the identified acoustic sources 802a and 802b may be analyzed to produce a state of performance of a task by the components 802a and 802b. In an example, a state estimator or the anomaly detectors 206 are trained on signals generated by tools and/or actuators performing tasks to estimate state of performance of the tasks. For example, in some embodiments, the anomaly detectors 206 may be configured to detect a predictive pattern indicative of the state of the performance of the task by the components 802a and 802b. For example, real-valued time series of isolated signals 1 and 2 collected over a period can include a normal region and, in some cases, an abnormal region leading to a point of failure of any or both of the components 802a and 802b. The anomaly detectors 206 may be configured to detect any such abnormal region to prevent the failure of any of the components 802a or 802b. For example, in some implementations, the anomaly detectors 206 may use a Shapelet discovery method to search for the predictive pattern until the best predictive pattern is found. To this end, based on identification of any anomalous predictive pattern that may lead to a failure in the machine 802, a control command may be selected from a set of control commands. In an example, the set of control commands may be based on different states of performance of different tasks, different predictive patterns, different anomalous behaviors, and so forth. To this end, the selected control command may be transmitted to the machine 802 to cause the machine 802 to execute the control command. For example, such control command, when executed, may stop the machine 802, stop an anomalous component of the machine 802, raise a request for maintenance of the machine 802 and/or any of the components 802a or 802b, schedule a diagnostic or maintenance activity for the machine with a technical expert, and so forth.

In effect, the state estimation based on extracted signal adapts the control to different kinds of complex manufacturing. However, some embodiments are not limited to only factory automation. For example, in one embodiment, the controlled machine is a gearbox to be monitored for potential anomalies, and the gearbox can only be recorded in the presence of vibrations from the motor, coupling, or other vibrations from the moving part.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An audio system for facilitating an operation of a machine including one or multiple actuators assisting one or multiple tools to perform one or multiple tasks, comprising:
an audio input interface configured to receive an audio mixture of signals generated by multiple audio sources including at least one of: the one or multiple tools performing one or multiple tasks, or the one or multiple actuators operating the one or multiple tools, wherein at least one of the audio sources forming the audio mixture is identified by a location relative to a location of each microphone of a microphone array measuring the audio mixture;
a processor configured to extract an audio signal generated by an identified audio source of the multiple audio sources from the audio mixture based on a correlation of spectral features in a multi-channel spectrogram of the audio mixture with directional information indicative of the relative location of the identified audio source; and
an output audio interface configured to output the extracted audio signal to facilitate the operation of the machine.

2. The audio system of claim 1, wherein the processor is configured to extract the audio signal generated by the identified audio source using a neural network.

3. The audio system of claim 2, wherein
the spectral features include inter-channel phase differences of channels in the multi-channel spectrogram of the audio mixture,
the directional information includes target phase differences (TPDs) of a sound propagating from the relative location of the identified audio source to different microphones in the microphone array,
the correlation of the spectral features and the directional information is represented by a target phase correlation spectrogram, wherein values for different time-frequency bins of the target phase correlation spectrogram quantify alignment of the inter-channel phase differences with the target phase differences in the corresponding time-frequency bins, and wherein the target phase differences are expected phase differences for the time-frequency bins indicative of properties of sound propagation,
wherein the processor is further configured to:
determine the target phase correlation spectrogram; and
process the target phase correlation spectrogram with the neural network to extract the audio signal.

4. The audio system of claim 3, wherein the target phase correlation spectrogram includes complex numbers, and wherein the neural network is a complex neural network for processing the complex numbers of the target phase correlation spectrogram.

5. The audio system of claim 4, wherein the complex neural network has a complex U-net architecture.

6. The audio system of claim 5, wherein the complex U-net architecture comprises:
a complex convolutional encoder;
a complex bidirectional long short-term memory (BLSTM) module arranged to process outputs of the complex convolutional encoder; and
a complex convolutional decoder arranged to process the outputs of the complex convolutional encoder and outputs of the complex BLSTM module.

7. The audio system of claim 6, wherein the neural network is trained to extract signals of multiple identified audio sources and wherein the complex U-net architecture includes at least one complex convolutional decoder for each of the identified audio sources.

8. The audio system of claim 2, wherein the processor is further configured to:
determine the target phase correlation spectrogram for the audio mixture using the neural network.

9. The audio system of claim 2, wherein, to train the neural network, the processor is further configured to:
receive a training audio mixture of signals generated by one or more training audio sources including at least one of: one or more tools performing one or more tasks, or one or more actuators operating the one or more tools, wherein at least one of the one or more training audio sources forming the training audio mixture is identified by location data relative to the location of each microphone of the microphone array measuring the training audio mixture;
generate one or more training target phase correlation spectrograms associated with corresponding training audio sources, the one or more training target phase correlation spectrograms being generated based on a correlation between spectral features of the training audio mixture and directional features indicative of the location data of the one or more training audio sources forming the training audio mixture, wherein each time-frequency (TF) bin of the one or more training target phase correlation spectrograms defines a feature that quantifies a match between inter-channel phase differences observed in the spectral features of the measured training audio mixture and corresponding expected phase differences indicative of properties of sound propagation for the corresponding location data of the one or more training audio sources relative to location of each microphone of the microphone array; and
train the neural network to extract training audio signals corresponding to the one or more training audio sources based on the respective one or more training target phase correlation spectrograms.

10. The audio system of claim 9, wherein, to train the neural network, the processor is further configured to:
train the neural network based on a set of loss functions, the set of loss functions comprising at least one of: a location loss function corresponding to each of the separated training audio signals for the training audio sources, or a reconstruction loss function associated with a summation of the extracted training audio signals for reconstructing the training audio mixture.

11. The audio system of claim 9, wherein, to compute the location loss functions, the processor is configured to:
compute ideal target phase correlation spectrogram using physical properties of sound propagation for the one or more training audio sources based on location data for each of the one or more training audio sources; and
compute estimated training target phase correlation spectrogram associated with corresponding training audio sources, the one or more estimated training target phase correlation spectrograms being generated based on a correlation between spectral features associated with corresponding separated training audio signals and directional features indicative of the location data of the one or more training audio sources forming the training audio mixture, wherein each time-frequency (TF) bin of the one or more estimated training target phase correlation spectrograms defines a feature that quantifies a match between inter-channel phase differences observed in the spectral features of the corresponding separated training audio signals and corresponding expected phase differences indicative of properties of sound propagation for the corresponding location data of the one or more training audio sources relative to location of each microphone of the microphone array; and determine a difference between the estimated training target phase correlation spectrogram and the corresponding ideal target phase correlation spectrogram for each of the one or more training audio sources, wherein the difference indicates the location loss functions.

12. The audio system of claim 9, wherein, to train the neural network, the processor is further configured to:
collect the training audio mixture generated by the one or more training audio sources by moving the microphone array in different locations in proximity to the machine.

13. The audio system of claim 1, wherein the processor is further configured to:
transform the received audio mixture with Fourier transformation to produce a multi-channel short-time Fourier transform (STFT) of the received audio mixture;
determine inter-channel phase differences (IPDs) between different channels of the multi-channel STFT;
determine target phase differences (TPDs) of a sound propagating from the relative location of the identified audio source to different microphones in the microphone array;
correlate the IPDs with the TPDs to produce a target phase correlation spectrogram, wherein values of the target phase correlation spectrogram for different time-frequency bins quantify alignment of the IPDs with the TPDs in the corresponding time-frequency bins, and wherein the TPD is the expected phase difference for the time-frequency bin indicative of properties of sound propagation;
combine the target phase correlation spectrogram with the multi-channel STFT and frequency position encodings to produce channel concatenation of the received audio mixture; and
process the channel concatenation of the received audio mixture with a neural network to extract the audio signal.

14. The audio system of claim 13,
wherein, to determine the IPDs, the processor is configured to:
compare complex values of different channels with a reference channel in the multi-channel STFT to produce inter-channel phase angle differences (IPDs) with respect to a reference microphone in the microphone array, and
represent the IPDs as complex numbers, each of the complex numbers having a real part indicative of a cosine of a corresponding phase angle difference from the phase angle differences and an imaginary part indicative of a sine of the corresponding phase angle difference to produce a complex conjugate of each of the represented complex IPDs,
wherein, to determine the TPDs, the processor is configured to:
compute target phase angle differences (TPDs) between when the sound propagating from the identified source in the audio mixture arrives at the different channels with the reference channel based on position values of the machine and microphones in the microphone array, and
represent the TPDs as complex numbers, each of the complex numbers having a real part indicative of a cosine of a corresponding target phase angle difference from the produced target phase angle differences and an imaginary part indicative of a sine of the corresponding target phase angle difference to produce a complex conjugate of each of the represented complex TPDs, and
wherein, to determine the target phase correlation spectrogram, the processor is configured to:
compute products for each of the complex conjugates of the complex IPDs and the corresponding complex conjugates of the complex TPDs for each time-frequency bin, and
determine a sum of each of the products over all non-reference channels.

15. The audio system of claim 1, wherein the processor is further configured to:
produce a control command for the operation of the machine based on the extracted signal; and
transmit the control command to the machine over a communication channel.

16. The audio system of claim 15, wherein the processor is further configured to:
analyze the extracted audio signal generated by the identified acoustic source from the audio mixture to produce a state of performance of a task;
select the control command from a set of control commands based on the state of performance of the task, wherein the set of control commands correspond to different states of performance of the one or multiple tasks; and
cause the machine to execute the control command.

17. The audio system of claim 15, wherein the processor is further configured to:
determine an anomaly score for the identified acoustic source based on the extracted audio signal corresponding to the identified audio source, wherein the anomaly score indicates a correlation between a type of an anomaly and a state of the identified acoustic source;
compare the anomaly score with an anomaly threshold;
select the control command from a set of control commands to be performed by the machine when the anomaly score is greater than the anomaly threshold; and
transmit the selected control command to the machine for overcoming an anomaly at the identified acoustic source.

18. The audio system of claim 1, wherein the multiple audio sources generating the audio mixture belong to a same class, and wherein the processor is further configured to:
extract an audio signal generated by each of the multiple audio sources from the audio mixture based on a correlation of spectral features in a multi-channel spectrogram of the audio mixture with directional information indicative of relative locations corresponding to the multiple audio sources.

19. A system for facilitating an operation of a machine including one or multiple actuators assisting one or multiple tools to perform one or multiple tasks, comprising:
a processor; and
a memory having instructions stored thereon that cause the processor to:
receive an audio mixture of signals generated by multiple audio sources including at least one of: the one or multiple tools performing the one or multiple tasks, or the one or multiple actuators operating the one or multiple tools, wherein at least one of the audio sources forming the audio mixture is identified by a location relative to a location of each microphone of a microphone array measuring the audio mixture;
extract an audio signal generated by an identified audio source of the multiple audio sources from the audio mixture based on a correlation of spectral features in a multi-channel spectrogram of the audio mixture with directional information indicative of the relative location of the identified audio source; and
output the extracted audio signal to facilitate the operation of the machine.

20. A method for facilitating an operation of a machine including one or multiple actuators assisting one or multiple tools to perform one or multiple tasks, comprising:
receiving, using an audio input interface, an audio mixture of signals generated by multiple audio sources including at least one of: one or multiple tools performing one or multiple tasks, or one or multiple actuators operating the one or multiple tools, wherein at least one of the audio sources forming the audio mixture is identified by a location relative to a location of each microphone of a microphone array measuring the audio mixture;
extracting, using a processor, an audio signal generated by an identified audio source of the multiple audio sources from the audio mixture based on a correlation of spectral features in a multi-channel spectrogram of the audio mixture with directional information indicative of the relative location of the identified audio source; and
outputting, using an output audio interface, the extracted audio signal to facilitate the operation of the machine.
